(19) United States
(12) Patent Application Publication
(10) Pub. No.: US 2015/0079555 A1
(43) Pub. Date: Mar. 19, 2015

(54) READING DISABILITY SCREENING SYSTEM

(71) Applicant: Groves Academy, St. Louis Park, MN (US)

(72) Inventor: John F. Alexander, Minneapolis, MN (US)

(21) Appl. No.: 14/490,236

(22) Filed: Sep. 18, 2014

Related U.S. Application Data
(60) Provisional application No. 61/879,533, filed on Sep. 18, 2013.

(51) Int. Cl. G09B 7/04; G09B 17/00

(52) U.S. Cl. CPC G09B 7/04; G09B 17/003
USPC 434/169

(57) ABSTRACT

A preliminary assessment of a child is provided to evaluate a child's risk of developing a reading disability. When the preliminary assessment determines that the child has a high risk of developing a reading disability, formal assessment of the child is recommended.

### CROSS-REFERENCE TO RELATED APPLICATION

This application claims priority to U.S. Application No. 61/879,533, filed on Sep. 18, 2013, and titled READING DISABILITY SCREENING SYSTEM, the disclosure of which is hereby incorporated by reference in its entirety.

### BACKGROUND

A reading disability is the inability of a child, with otherwise good potential, to read fluently (with accuracy and appropriate pace) and/or with good comprehension. For most children, the reading disability affects the child's ability to read accurately the printed word. The inability to read isolated words affects the child's ability to read fluently—with accuracy and proper speed. We all have limited cognitive capacity. If a child is spending an inordinate amount of mental energy in reading words on the page, he or she does not have enough mental capacity to make meaning of what he is reading and comprehension suffers. Children need to reach a level of automaticity with decoding words so that they have the mental energy to process what they are reading.

Reading disabilities are the most prevalent form of learning disability, accounting for about 80% of all learning disabilities. Approximately 10 to 15 percent of English speakers have a reading disability known as dyslexia. Children with dyslexia fall on a continuum. One can be mildly affected or significantly affected. The good news is that the prognosis for dyslexic children is good, especially if they are identified early. Unfortunately, many children are not identified early. Such a failure to identify the reading disability early can cause great harm to the child, which may last for the child's lifetime.

### SUMMARY

In general terms, this disclosure is directed to a system for screening for a reading disability. In one possible configuration and by non-limiting example, the system provides a preliminary assessment of a child that evaluates the child for risk factors associated with childhood reading disabilities, and if a risk is identified, the child is recommended for formal assessment. Various aspects are described in this disclosure, which include, but are not limited to, the following aspects.

One aspect is a method of performing a preliminary assessment of a child to evaluate the child's risk of developing a reading disability, the method comprising: assessing, using at least one computing device, a history of the child to at least identify whether the child has a family history of reading disability; assessing the child's rhyming ability; assessing the child's ability to recognize letters of an alphabet; assessing the child's ability to identify particular sounds; and using the results of the assessments to evaluate the child's risk of developing a reading disability.

Another aspect is a screening system comprising: a processing device; and at least one computer readable storage device, the at least one computer readable storage device storing data instructions that when executed by the processing device cause the processing device to generate: an assessment engine operable to present a preliminary assessment to a child to evaluate the child's risk of developing a reading disability; a scoring engine operable to determine a score based on the preliminary assessment; and a recommendation engine configured to generate a recommendation based on the score, wherein the recommendation engine recommends that the child be formally assessed for a reading disability when the score indicates that the child has a high risk of developing a reading disability.

### BRIEF DESCRIPTION OF THE DRAWINGS

FIG. 1 is a schematic block diagram illustrating an example system for treating a reading disability.

FIG. 2 is a schematic block diagram illustrating an example screening system.

FIG. 3 illustrates an example architecture of a computing device that can be used to implement aspects of the present disclosure.

FIG. 4 is a schematic block diagram of an example data store of the screening system shown in FIG. 2.

FIG. 5 is a flow chart illustrating an example method of providing an age appropriate preliminary assessment.

FIG. 6 is a schematic block diagram illustrating an example preliminary assessment.

FIG. 7 is a schematic block diagram illustrating another example of a preliminary assessment.

FIG. 8 is a screen shot of an example welcome page.

FIG. 9 is a screen shot of an example registration page.

FIG. 10 is a screen shot of an example history assessment page.

FIG. 11 is a screen shot of an example spatial understanding assessment page.

FIG. 12 is a screen shot of an example rhyming assessment page.

FIG. 13 is a screen shot of another example rhyming assessment page.

FIG. 14 is a screen shot of an example letter recognition assessment page.

FIG. 15 is a screen shot of an example letter recognition assessment page.

FIG. 16 is a screen shot of an example counting words assessment page.

FIG. 17 is a screen shot of an example compound words assessment page.

FIG. 18 is a screen shot of an example syllable level words assessment page.

FIG. 19 is a screen shot of an example first words assessment page.

FIG. 20 is a screen shot of an example last sounds assessment page.

FIG. 21 is a screen shot of an example counting sounds assessment page.

FIG. 22 is a flow chart illustrating an example method of scoring a preliminary assessment.

FIG. 23 is a flow chart illustrating an example method of generating a recommendation based on a preliminary assessment.

FIG. 24 is a flow chart illustrating an example method of providing resources relating to a preliminary assessment.

FIG. 25 is a screen shot illustrating an example assessment results page.

FIG. 26 illustrates an example of a letter to a school or school district requesting a formal assessment of a child found to be at risk of developing a reading disability.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

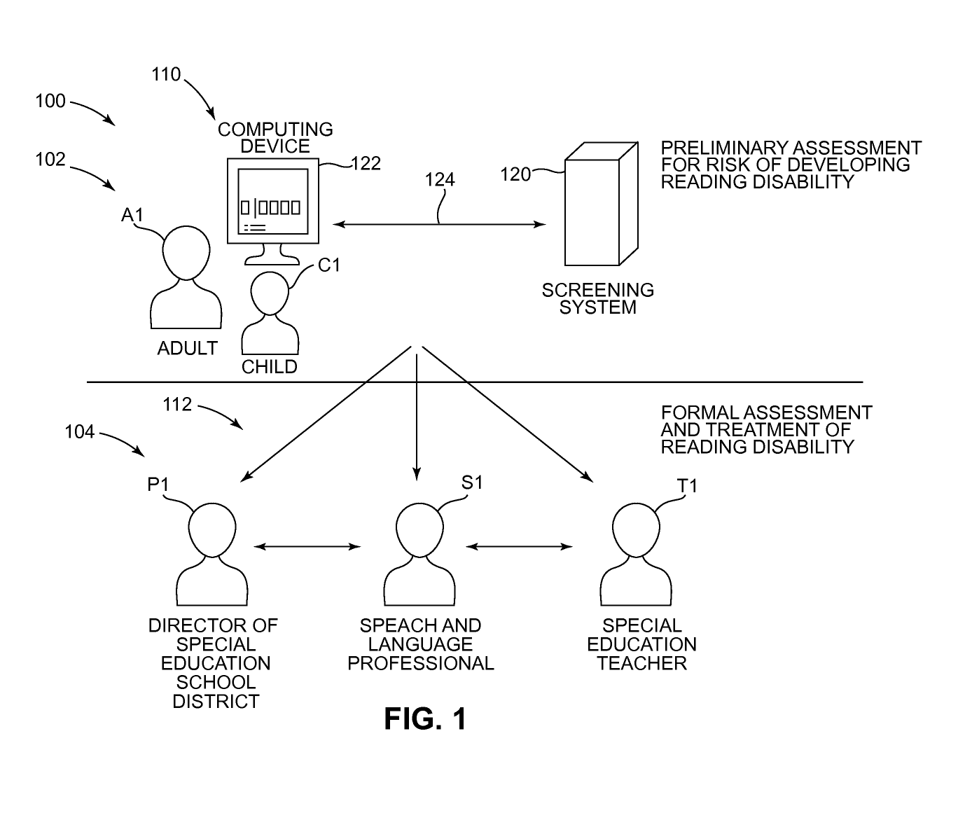

FIG. 1 is a schematic block diagram illustrating an example system 100 for treating a reading disability of a child C1. The diagram also illustrates two exemplary stages in treating the child's reading disability. The first stage 102 involves a preliminary assessment of the child C1 for risk of developing a reading disability. The second stage 104 involves a formal assessment and treatment of the child's C1 reading disability.

The system 100 includes a preliminary assessment system 110 and a formal assessment and treatment system 112. The preliminary assessment system 110 is primarily involved in the first stage 102, while the formal assessment and treatment system 112 is involved in the second stage 104.

During the first stage 102, the preliminary assessment system 110 operates to perform a preliminary assessment of the child C1 in order to evaluate whether or not the child is at risk of developing a reading disability. Because the system 110 performs a preliminary assessment that can be later followed up with a formal assessment in stage 104 if needed, the assessment does not need to be administered by a licensed professional. Instead, the assessment can be administered by the assistance of a suitable adult A1, such as the child's C1 parent or guardian, a relative, a teacher, a club leader, or other person capable of ensuring that proper responses are entered into the preliminary assessment system 110. In many cases the preliminary assessment of the child C1 is performed at home with the computing device 122. In other cases, however, the preliminary assessment can also be performed at other locations, such as at a school, club facility, or other suitable location with a computing device 122 present at that location.

In the illustrated example, a web-based implementation of the preliminary assessment system 110 is illustrated, which includes a screening system 120 and a computing device 122 that operate to communicate with each other across one or more data communication networks 124.

In some embodiments the screening system 120 is a web server computing device that sends web page data across the network 124, and the computing device 122 is a client computing device which receives the web page data and presents that data in the form of web pages through a web browser software application. Inputs are received from the adult A1 into the computing device 122 and sent back to the screening system 120. In other embodiments, the screening system 120 is implemented in other forms. For example, the screening system 120 can also be implemented as a software application operating on a single computing device, such as the computing device 122, or by multiple software applications that communicate with each other across a network, such as the Internet.

During the second stage 104, the formal assessment and treatment system 112 operates to perform a formal assessment of the child's C1 reading disability and to provide treatment to address the disability. The formal assessment is typically administered by a licensed practitioner, such as the speech and language professional S1. In one embodiment, a formal assessment can include cognitive testing as well as achievement testing in reading, spelling, mathematics, and written expression. Assessments for physical disorders can also be performed during this stage 104, such as an eye test to check for the presence of a visual impairment, which can be influencing the child's ability to visually identify words and letters when reading.

After a reading disorder has been formally confirmed, an appropriate plan of treatment can be developed and implemented, which may involve the participation of one or more, or all, of the director of special education P1 or school district, one or more speech and language professionals S1 or other professionals (such as an occupational therapist, a child psychologist, a physician, etc.), and a special education teacher T1 or other educator. In some situations, for example, the team will put together a written Individualized Education Plan (IEP) that details the specific goals and objectives that the team will assist the child C1 to meet during the course of a school year, and will work together over the course of the year to implement the plan.

The preliminary assessment performed in stage 102 is critical to identifying that the child C1 is at risk for developing a reading disability early in the child's development. Without the preliminary assessment of stage 102, the second stage 104 often will not occur, or will not occur until very late in the child's development—at a point where it is much more difficult to address. There are various reasons for this. One reason is that parents are unlikely to recognize a reading disability until the child C1 has fallen significantly behind other children of his or her same age. Even then, parents may avoid taking remedial action thinking that they can just work harder with the child C1, or that they should give the child C1 more time to learn to read in school. Many educators are also reluctant to recommend children for evaluation for a reading disability for fear of stigmatizing the children by labeling them with a reading disability. Other educators may mistakenly believe that it is merely a maturity issue and that the reading “light bulb” will go on when a child's brain has sufficiently matured. Whatever the reason, without the preliminary assessment in stage 102, sufficient time may lapse before the child's C1 reading disability is identified. When such time has passed, significant damage may have occurred, and such damage may last for the child's C1 lifetime.

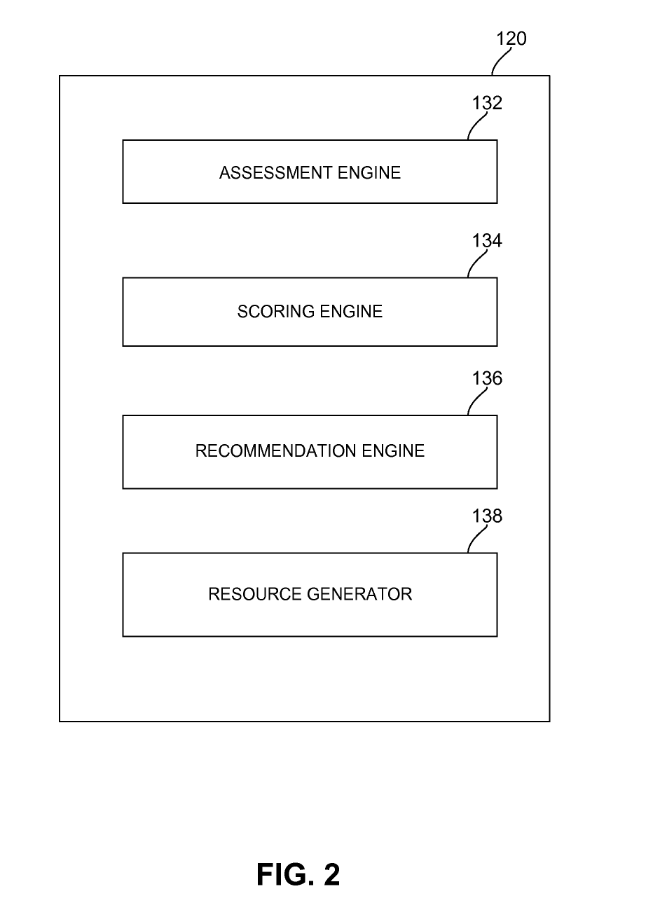

FIG. 2 is a schematic block diagram illustrating an example of the screening system 120. In this example, the screening system 120 includes an assessment engine 132, a scoring engine 134, a recommendation engine 136, and a resource generator 138.

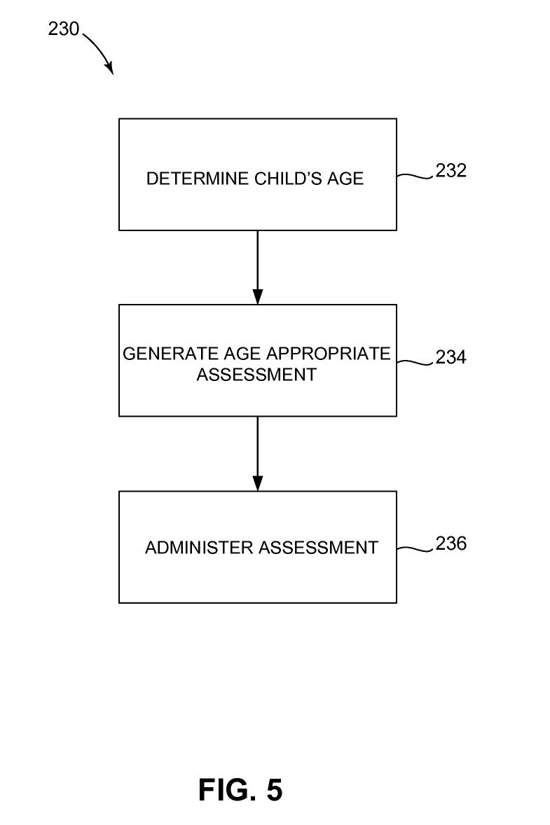

The assessment engine 132 generates and presents an assessment to the child C1 to evaluate the child for risk of developing a reading disability. In some embodiments, the assessment includes a set of questions. At least some of the questions are posed to the child to evaluate one or more aspects of the child's abilities. In some embodiments, at least some of the questions are presented through a video, including an audio recording, which presents instructions to the child. A response is received for each question. For some questions, the response indicates whether or not the child C1 answered the question correctly or incorrectly, for example. Examples of the operation of the assessment engine 132 are illustrated and described in more detail with reference to FIGS. 5-21.

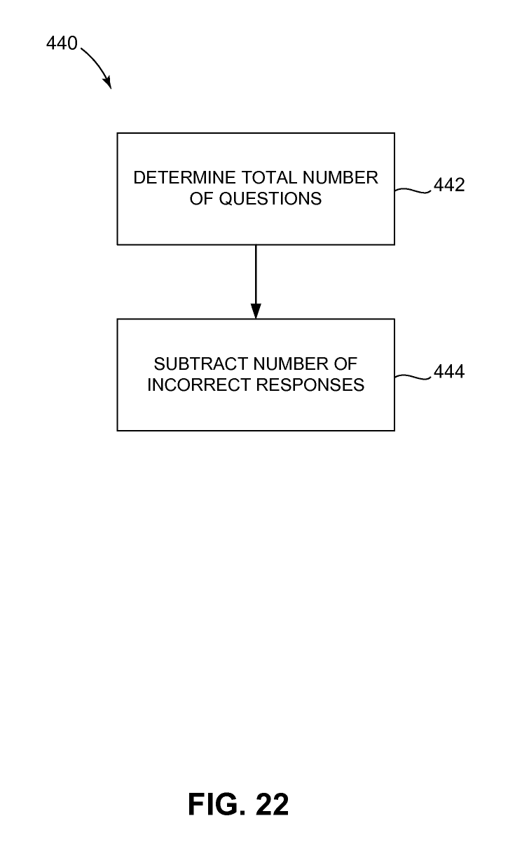

The scoring engine 134 evaluates the results of the assessment presented by the assessment engine 132 and generates a score. An example of the scoring engine 134 is illustrated and described in more detail with reference to FIG. 22.

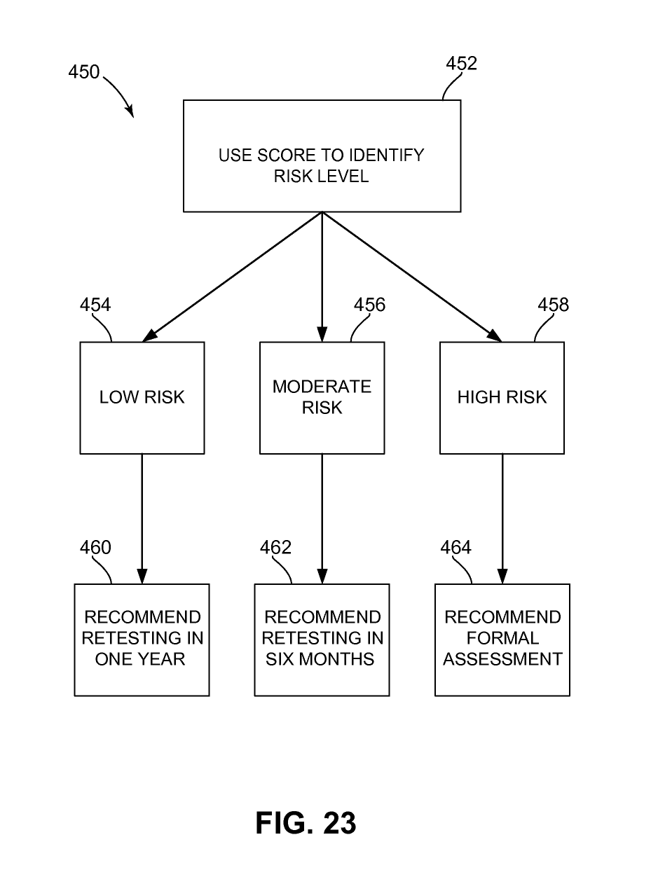

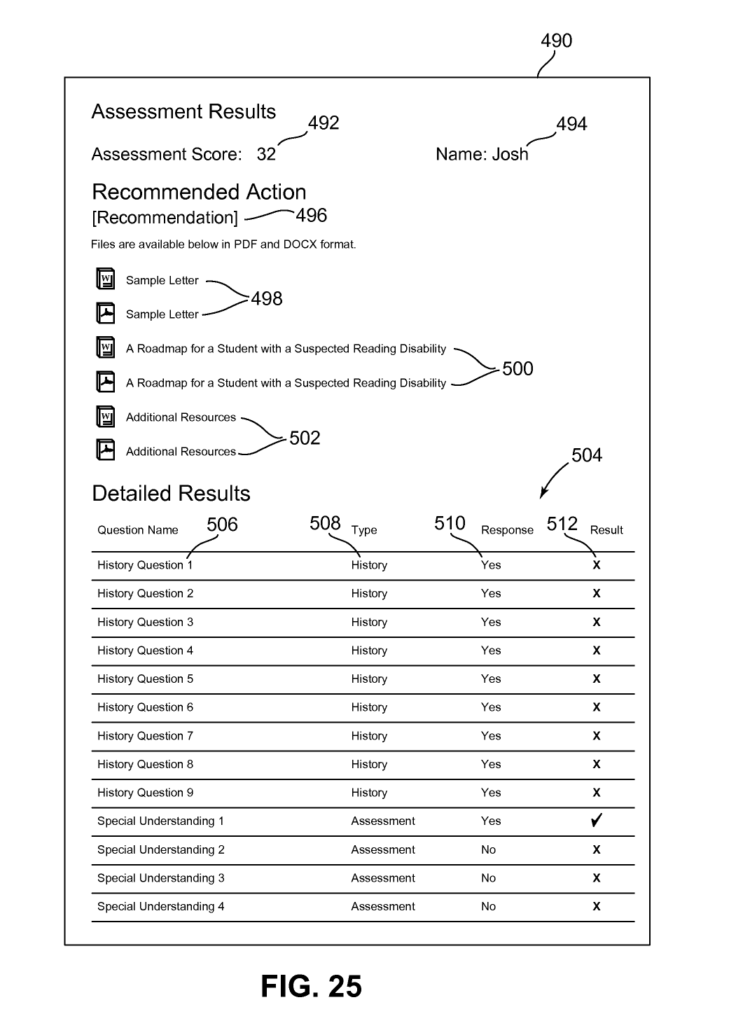

The recommendation engine 136 utilizes the score generated by the scoring engine 134 to generate and present a recommendation for the child. In some embodiments, for example, the recommendation engine identifies whether or not the child C1 is at risk of developing a reading disability. An example of the recommendation engine is illustrated and described in more detail with reference to FIGS. 23 and 25.

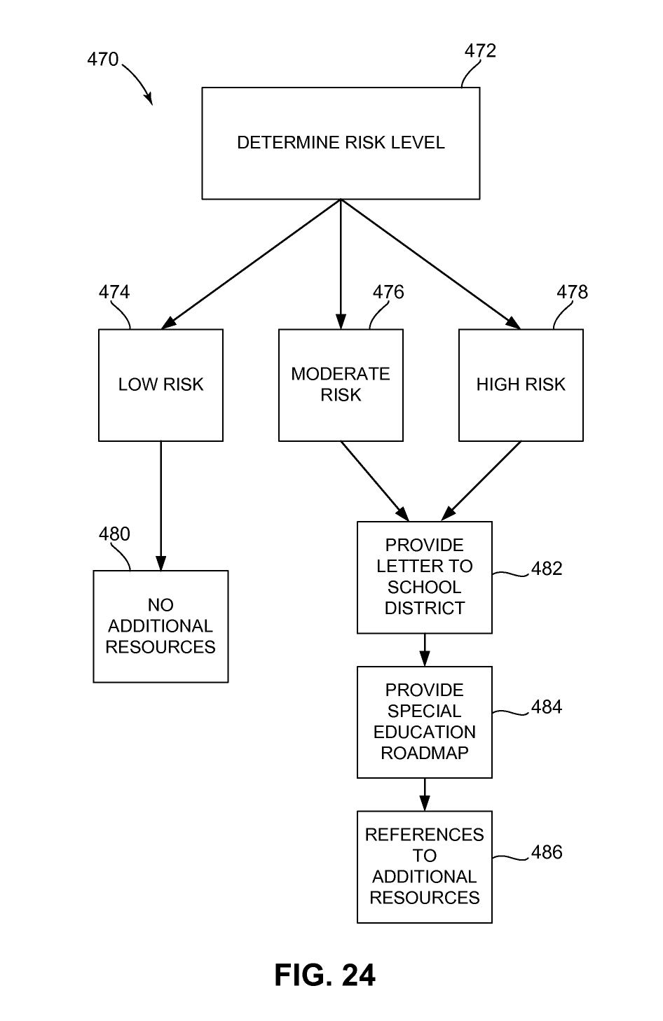

If the child C1 is found to be at risk of developing a reading disability, the resource generator 138 provides one or more additional resources. The resources can include, for example, educational resources to provide more information about or relating to reading disabilities. An example of the resource generator 138 is illustrated and described in more detail with reference to FIGS. 24-26.

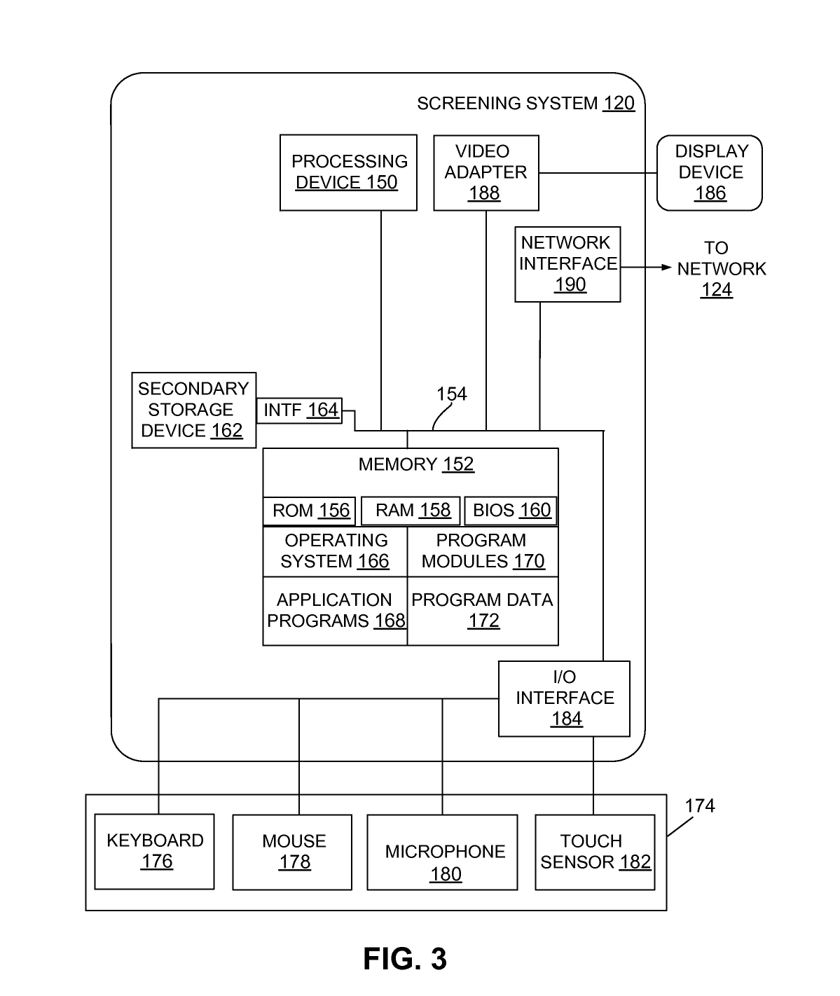

FIG. 3 illustrates an exemplary architecture of a computing device that can be used to implement aspects of the present disclosure, including any of the plurality of computing devices utilized by the adult A1, child C1, director of special education P1, speech and language professional S1, and special education teacher T1, or the computing device of the screening system 120. The computing device illustrated in FIG. 3 can be used to execute any one or more of the application programs and software engines described herein. By way of example, the computing device will be described below as an example of the screening system 120. To avoid undue repetition, this description of an example computing device will not be separately repeated herein for each of the other possible computing devices, including those discussed above, but such devices can also be configured as illustrated and described with reference to FIG. 3.

The screening system 120 includes, in some embodiments, at least one processing device 150, such as a central processing unit (CPU). A variety of processing devices are available from a variety of manufacturers, for example, Intel or Advanced Micro Devices. In this example, the screening system 120 also includes a system memory 152, and a system bus 154 that couples various system components including the system memory 152 to the processing device 150. The system bus 154 is one of any number of types of bus structures including a memory bus, or memory controller; a peripheral bus; and a local bus using any of a variety of bus architectures.

An example of the screening system 120 is a computing device such as a server computer. The computing device may include one or more computing devices, and one or more data storage devices, which can be configured as a single unit or can be distributed across multiple locations but in data communication with each other across one or more data communication networks 124. Other examples of computing devices suitable for one or more of the computing devices described herein include a desktop computer, a laptop computer, a tablet computer, a mobile computing device (such as a smart phone, an iPod® or iPad® mobile digital device, or other mobile devices), or other devices configured to process digital instructions.

The system memory 152 includes read only memory 156 and random access memory 158. A basic input/output system 160 containing the basic routines that act to transfer information within screening system 120, such as during start up, is typically stored in the read only memory 156.

The screening system 120 also includes a secondary storage device 162 in some embodiments, such as a hard disk drive or solid state memory, for storing digital data. The secondary storage device 162 is connected to the system bus 154 by a secondary storage interface 164. The secondary storage devices 162 and their associated computer readable media provide nonvolatile storage of computer readable instructions (including application programs and program modules), data structures, and other data for the screening system 120.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage. The example data store described herein includes computer readable storage media.

A number of program modules can be stored in secondary storage device 162 or memory 152, including an operating system 166, one or more application programs 168, other program modules 170 (such as the software engines described herein), and program data 172. The screening system 120 can utilize any suitable operating system, such as Microsoft Windows™, Google Chrome™, Apple OS, and any other operating system suitable for a computing device.

In some embodiments, a user provides inputs to the screening system 120 through input devices at the computing device 122, shown in FIG. 1. However, in other embodiments the user may provide input directly to the screening system 120 through one or more input devices 174. In either case, examples of input devices 174 include a keyboard 176, mouse 178, microphone 180, and touch sensor 182 (such as a touchpad or a touch sensitive display). Other embodiments include other input devices 174. The input devices are often connected to the processing device 150 through an input/output interface 184 that is coupled to the system bus 154. These input devices 174 can be connected by any number of input/output interfaces, such as a parallel port, serial port, game port, or a universal serial bus. Wireless communication between input devices and the interface 184 is possible as well, and includes infrared, BLUETOOTH® wireless technology, 802.11a/b/g/n, cellular, or other radio frequency communication systems in some possible embodiments.

In this example embodiment, a display device 186, such as a monitor, liquid crystal display device, projector, or touch sensitive display device, is also connected to the system bus 154 via an interface, such as a video adapter 188. In addition to the display device 186, the screening system 120 can include various other peripheral devices (not shown), such as speakers or a printer. Outputs can be presented in different embodiments through the display device 186 or the peripheral devices at the screening system 120 or at the computing device 122, shown in FIG. 1.

When used in a local area networking environment or a wide area networking environment (such as the Internet), the screening system 120 is typically connected to the network 124 through a network interface 190, such as an Ethernet interface. Other possible embodiments use other communication devices. For example, some embodiments of the screening system 120 include a modem for communicating across the network.

The screening system 120 typically includes at least some form of computer readable media. Computer readable media includes any available media that can be accessed by the screening system 120. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the screening system 120. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 3 is also an example of programmable electronics, which may include one or more such computing devices, and when multiple computing devices are included, such computing devices can be coupled together with a suitable data communication network 124 (FIG. 1) so as to collectively perform the various functions, methods, or operations disclosed herein.

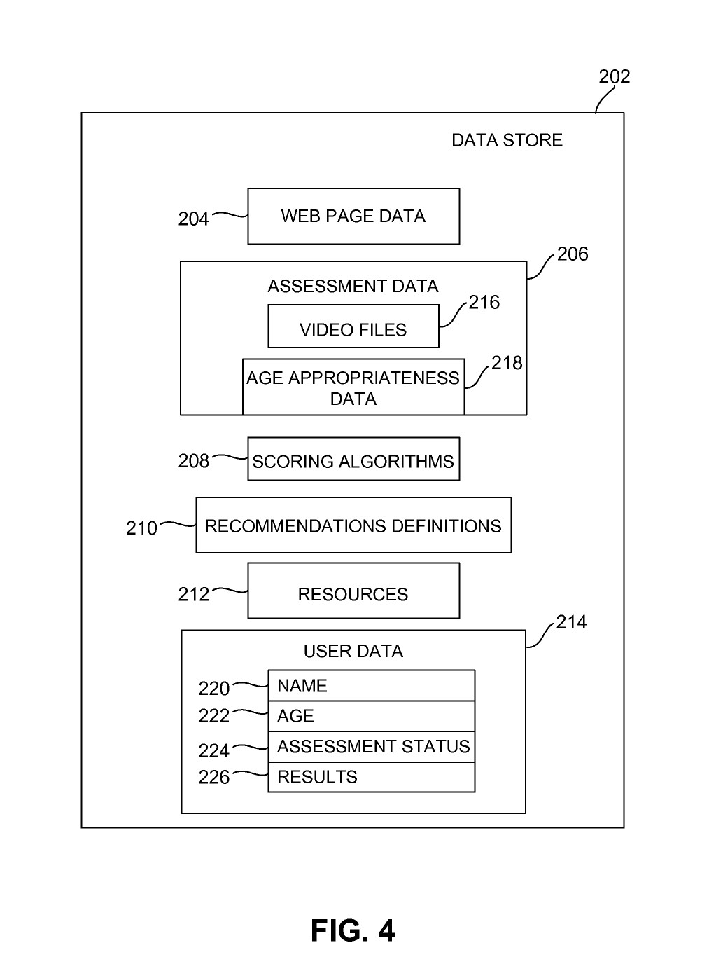

FIG. 4 is a schematic block diagram of an example data store 202. In this example, the data store 202 includes web page data 204, assessment data 206, scoring algorithms 208, recommendations definitions 210, resources 212, and user data 214.

The data store 202 includes one or more computer readable storage devices, such as described with reference to FIG. 3. In some embodiments, the data store 202 is or includes one or more of the memory 152 and secondary storage device 162, also discussed above. The data store 202 may be part of the screening system 120 or part of the computing device 122, located remotely and accessible through the data communication network 124, shown in FIG. 1.

Some embodiments include web page data 204 that stores digital data defining a plurality of web pages used to present the preliminary assessment to the child C1 and adult A1. The web page data is typically encoded in a standard markup language, such as a hypertext markup language (HTML), which is capable of being interpreted by a browser software application and rendered and displayed as web pages to the child C1 and adult A1. The web page data can also or alternatively include software code, such as Java script, Flash, and the like. In some embodiments, each step of the preliminary assessment is encoded as a separate web page with separate web page data 204.

Some embodiments do not include web page data. For example, in some embodiments the preliminary assessment is encoded as a software application (or software app). Web page data and software applications both include a form of data instructions that are executable by a processing device to perform one or more functions, steps, methods, operations, or other aspects of the preliminary assessment described herein.

The assessment data 206 contains the data used to generate and present the questions of the preliminary assessment to the child C1 and adult A1. In some embodiments, the assessment data 206 includes video files 216 and age appropriateness data 218.

The video files 216 encode a short video including an audio recording, which are used to present the questions to the child Cl. In some embodiments the questions are arranged in a series of sections, and the first video in each section includes introductory content for that section, such as instructions and example questions.

The age appropriateness data 218 is used by the assessment engine 132 to generate a preliminary assessment that is appropriate for the age of the child C1. In one example, the age appropriateness data 218 identifies for each question a minimum age at which the question is appropriate to be presented to a child. An example of the use of the age appropriateness data 218 is discussed in more detail with reference to FIG. 5.

The scoring algorithms 208 define the algorithms used to compute a score based on the results of the preliminary assessment. In some embodiments the score is a raw score based on the number of questions presented (as adjusted by the age appropriateness data 218). The scoring algorithms 208 are used by the scoring engine 134 (FIG. 2).

The recommendations definitions 210 are used by the recommendation engine 136 to generate appropriate recommendations based on the raw score generated by the scoring engine 134 (FIG. 2).

The resources 212 are used by the resource generator 138 (FIG. 2) to provide resources to the adult A1 to assist the adult A1 in better understanding and navigating the second stage 104 (FIG. 1) when the child C1 is determined to be at risk of developing a learning disability.

The user data 214 stores data for each child C1 that takes the preliminary assessment. In some embodiments, the user data 214 stores the child's C1 name 220, age 222, assessment status 224 (e.g., whether pending or completed, and a current question the child is on), and results 226. The results 226 stores the result for each question presented in the preliminary assessment, such as whether the question was completed correctly or incorrectly. In some embodiments a final score and/or recommendation is stored. In some embodiments the results 226 also include results for sections of the test, which can be helpful to identify the particular strengths and weaknesses of the child C1 prior to the formal assessment in stage 104 (FIG. 1).

FIG. 5 is a flow chart illustrating an example method 230 of providing an age appropriate preliminary assessment. In some embodiments the method 230 is performed by the assessment engine 132 (FIG. 2). In this example, the method 230 includes operations 232, 234, and 236.

A significant factor to consider when assessing a child's reading abilities is the child's age. The various reading skills are developed over time as a child gets older, but children that are progressing appropriately should have certain skills by certain ages. For example, children should be able to identify letters of the alphabet by the time that they enter first grade. Therefore, although it would not be a significant concern if a five year old child was not able to identify the letters of the alphabet, it would be a significant concern if a six year old child was not able to identify the letters of the alphabet. Therefore, it is important for a preliminary assessment to take into account the age of the child. Typically questions that are not appropriate for a given age need not be presented to the child C1, as such questions provide little insight into whether or not the child is likely to develop a reading disability, and may cause concern or even frustration to the child C1 and parent A1 if the child C1 is unable to correctly answer the questions that are likely above his or her ability.

The operation 232 is performed to determine a child's age. In some embodiments, the child's age is obtained by prompting a user to enter the age of the child C1. The age is stored in the age data 222 (FIG. 4). In another embodiment, the user is prompted to enter the child's C1 birthday, and the operation 232 computes the age at the present date.

The operation 234 is performed to generate an age appropriate assessment. In some embodiments, the operation 234 uses the age determined in the operation 232 and the age appropriateness data 218 (FIG. 4) to identify a set of age appropriate questions to be included in the preliminary assessment. For example, if the child's age is 7, the age appropriateness data 218 is used to identify those questions from the assessment data 206 that are appropriate for a 7 year old child. This is accomplished, for example, by comparing the child's age with the minimum age identified in the age appropriateness data 218 for each question, and determining whether the child's age is greater than or equal to the minimum age. Those questions are then identified as age appropriate, and identified for inclusion in the preliminary assessment.

The operation 236 is then performed to administer the age appropriate preliminary assessment to the child C1, using the questions that have been identified as age appropriate. Additional examples of the preliminary assessment are discussed herein.

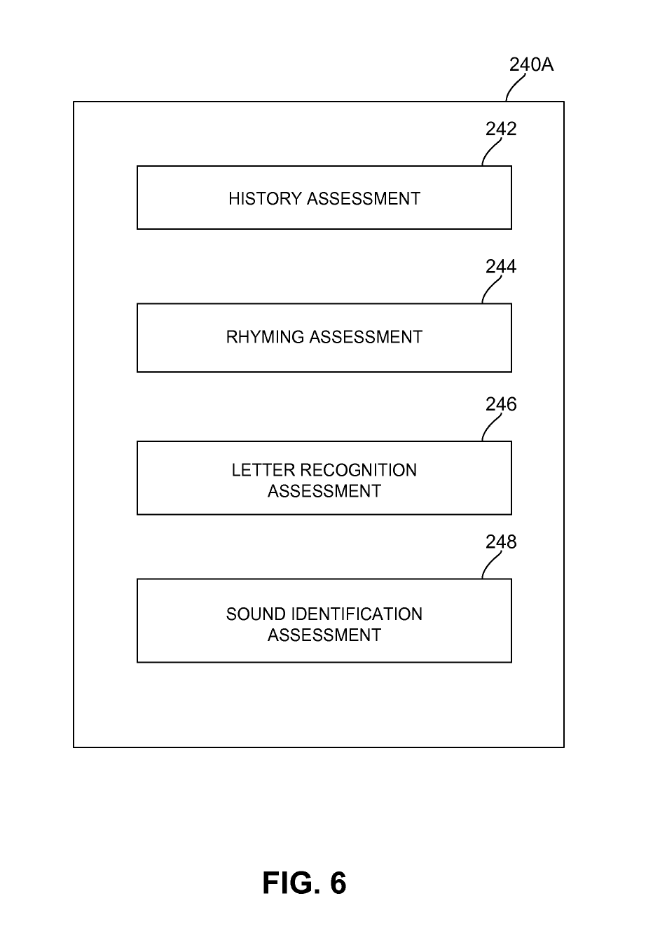

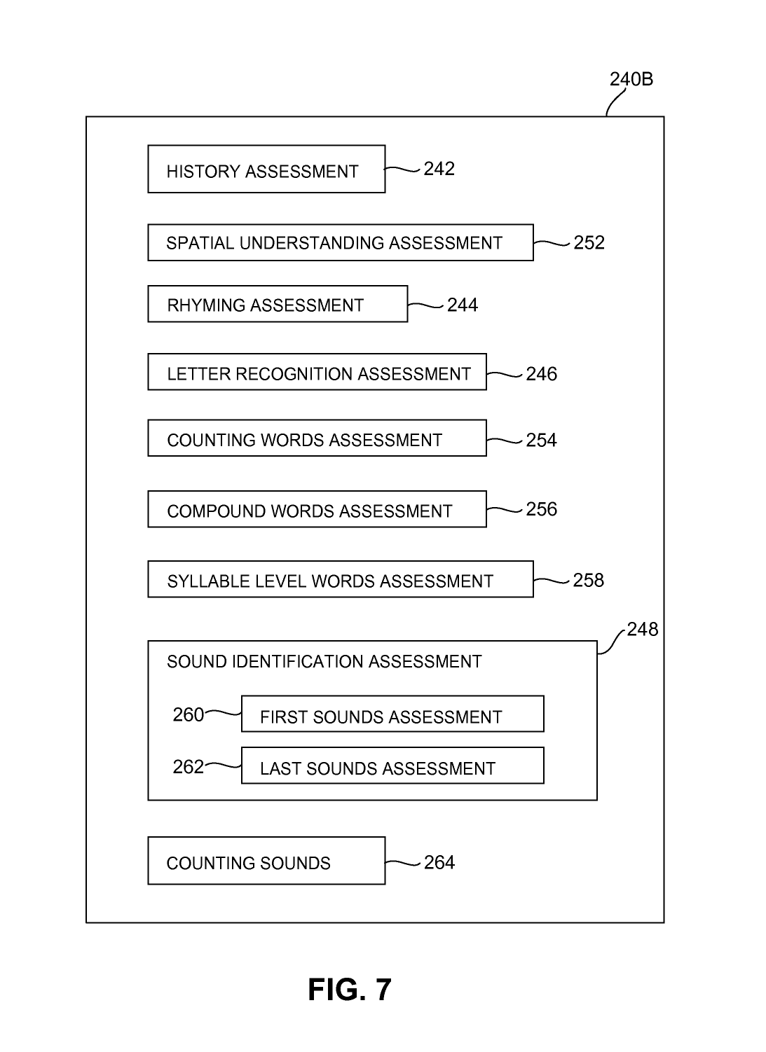

FIG. 6 is a schematic block diagram illustrating an example preliminary assessment 240A. In some embodiments, the preliminary assessment 240 is presented by the assessment engine 132 shown in FIG. 2. In this example, the preliminary assessment 240A includes multiple sections, including a history assessment 242, a rhyming assessment 244, a letter recognition assessment 246, and a sound identification assessment 248. Other embodiments include additional or different sections, such as illustrated in FIG. 7.

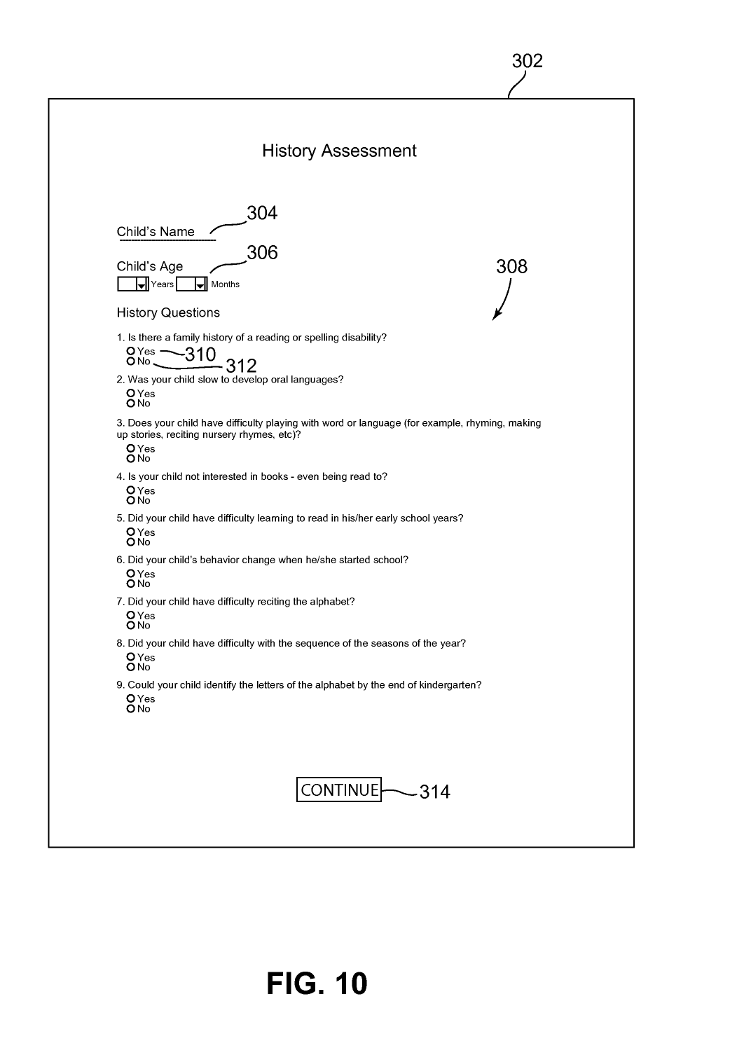

The history assessment 242 presents one or more questions relating to the child's C1 history. An example of a history assessment 242 is described with reference to FIG. 10.

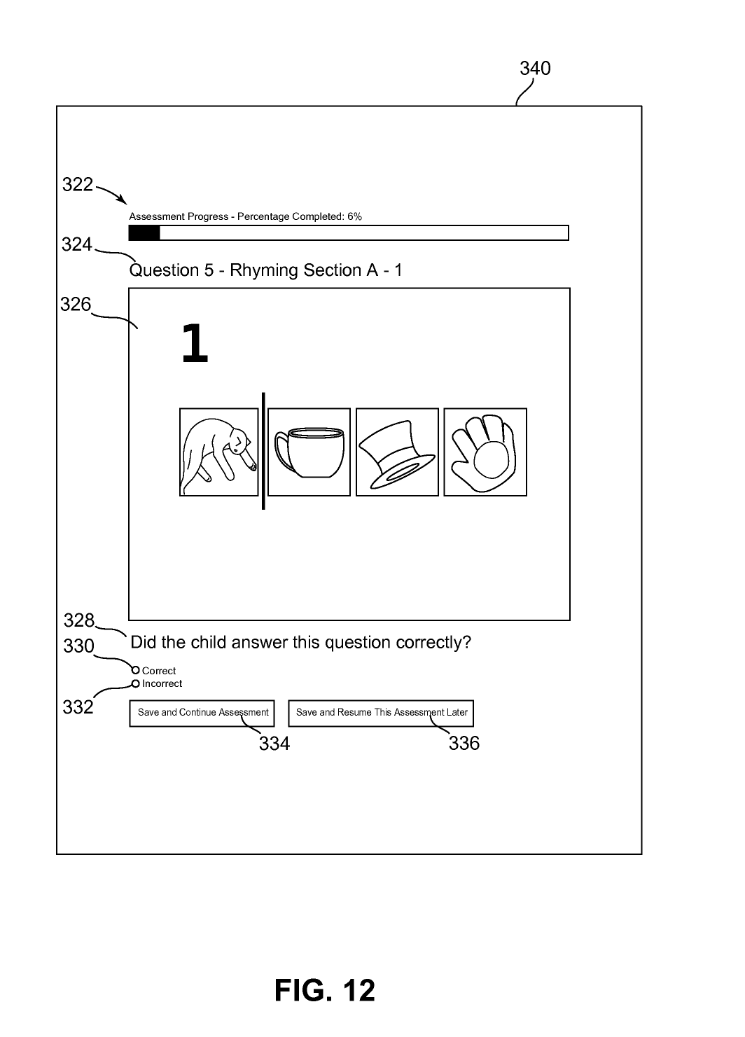

The rhyming assessment 244 presents one or more questions which ask the child C1 to identify words that rhyme. Two words rhyme when they end with the same sound. Examples of the rhyming assessment 244 are described with reference to FIGS. 12-14.

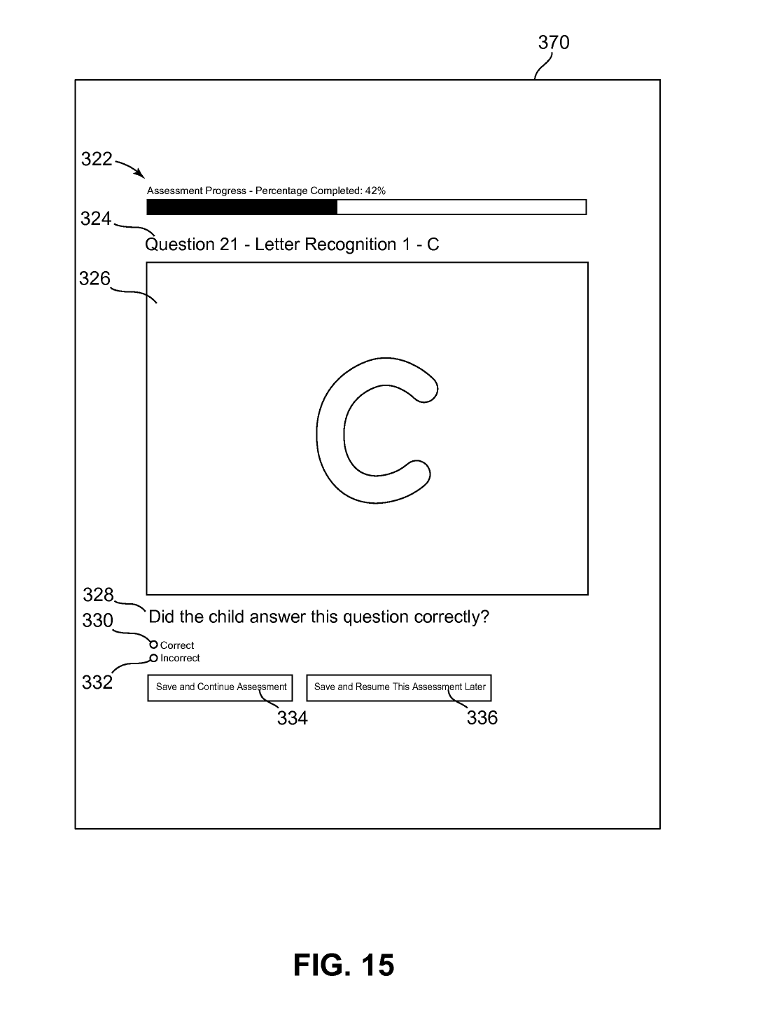

The letter recognition assessment 246 presents one or more questions which ask the child C1 to identify letters of the alphabet. For example, a picture of a letter is shown to the child C1 and the child is asked to identify the letter. An example of the letter recognition assessment 246 is described with reference to FIG. 15.

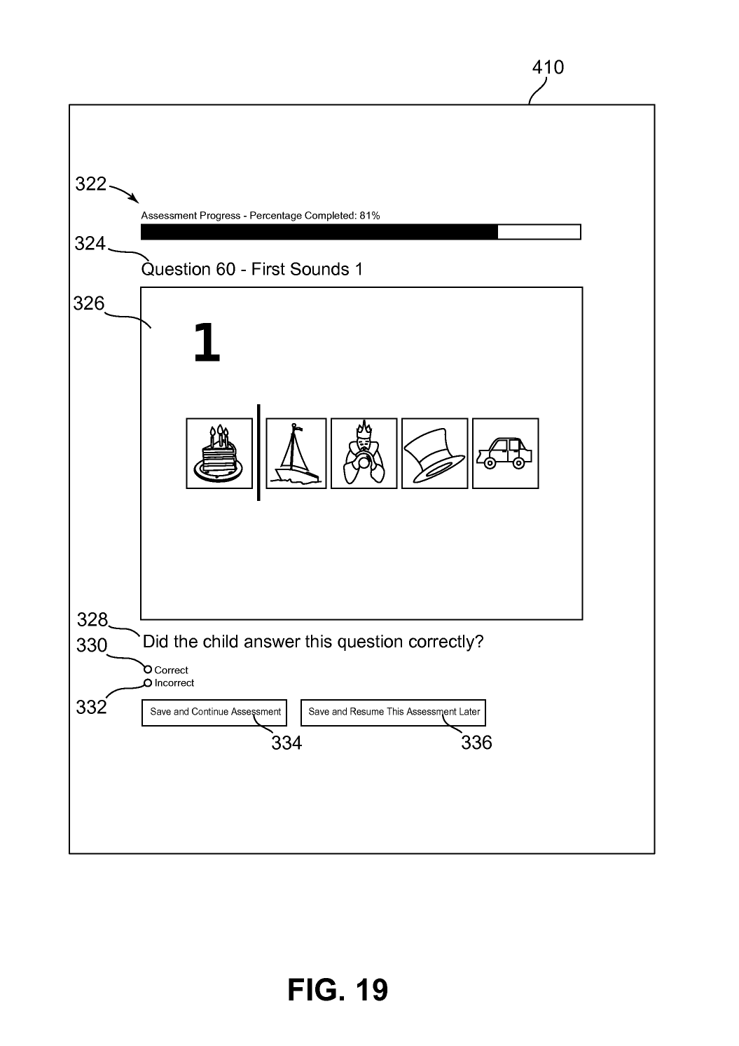

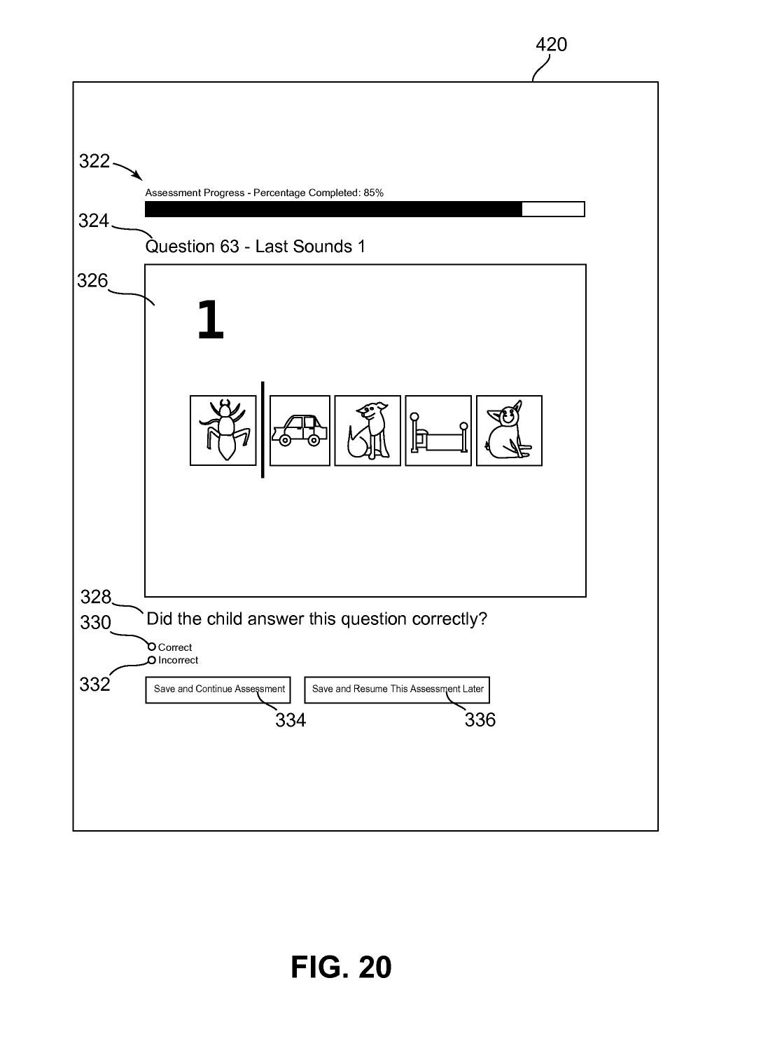

The sound identification assessment 248 presents one or more questions which ask the child C1 to identify certain sounds. For example, some embodiments ask the child C1 to identify words that share a common sound. Examples of the sound identification assessment 248 are described with reference to FIGS. 19-20.

Other embodiments of the preliminary assessment 240 include more or fewer sections, such as shown in FIG. 7.

FIG. 7 is a schematic block diagram illustrating another example of a preliminary assessment 240B. In this example, the preliminary assessment includes a plurality of sections including one or more of the history assessment 242, a spatial understanding assessment 252, the rhyming assessment 244, the letter recognition assessment 246, a counting words assessment 254, a compound words assessment 256, a syllable level words assessment 258, the sound identification assessment 248 including a first sounds assessment 260 and a last sounds assessment 262, and a counting sounds assessment 264.

The history assessment 242, rhyming assessment 244, letter recognition assessment 246, and sound identification assessment 248 were previously introduced in FIG. 6.

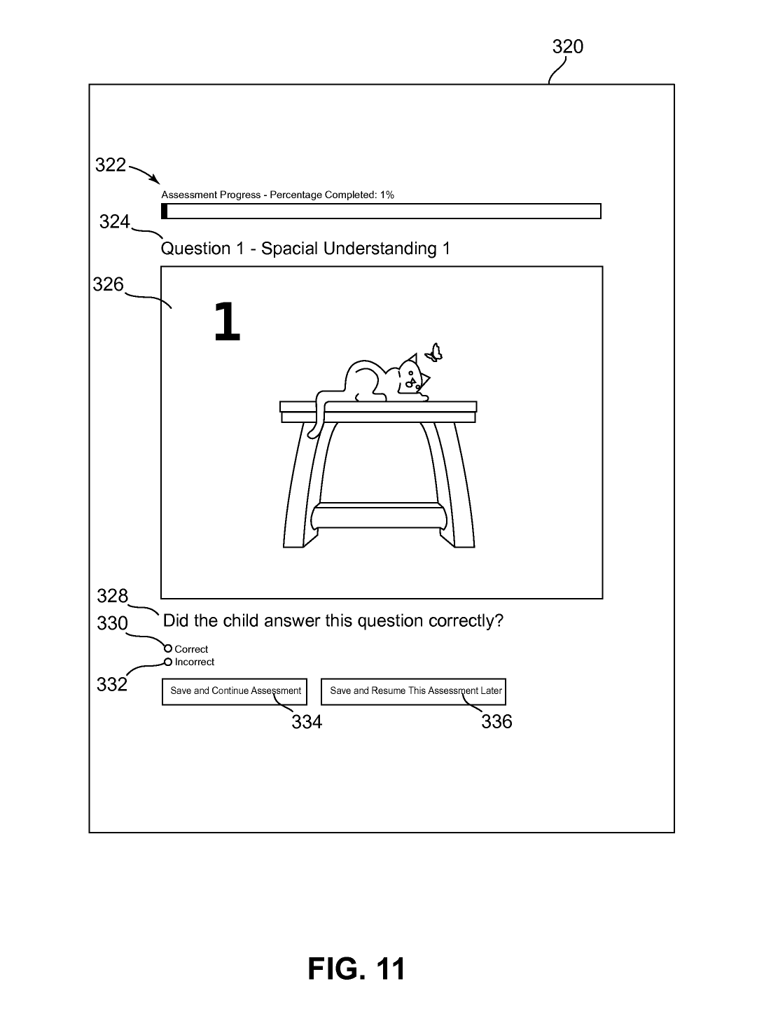

The spatial understanding assessment 252 presents one or more questions that evaluate a child's spatial understanding, such as whether a child understands the meaning of words that define a spatial relationship between two objects, such as above, on, below, under, etc. An example of the spatial understanding assessment 252 is described with reference to FIG. 11.

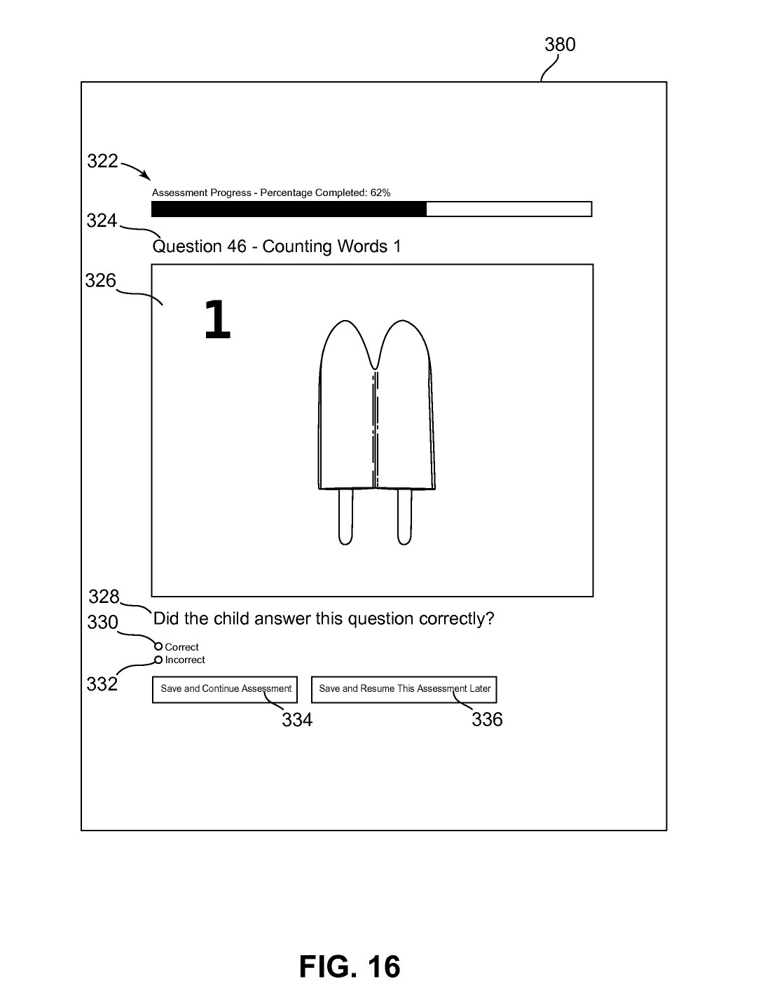

The counting words assessment 254 presents one or more questions that evaluate a child's ability to identify whole words, such as by counting the number of words in a phrase. An example of the counting words assessment 254 is described with reference to FIG. 16.

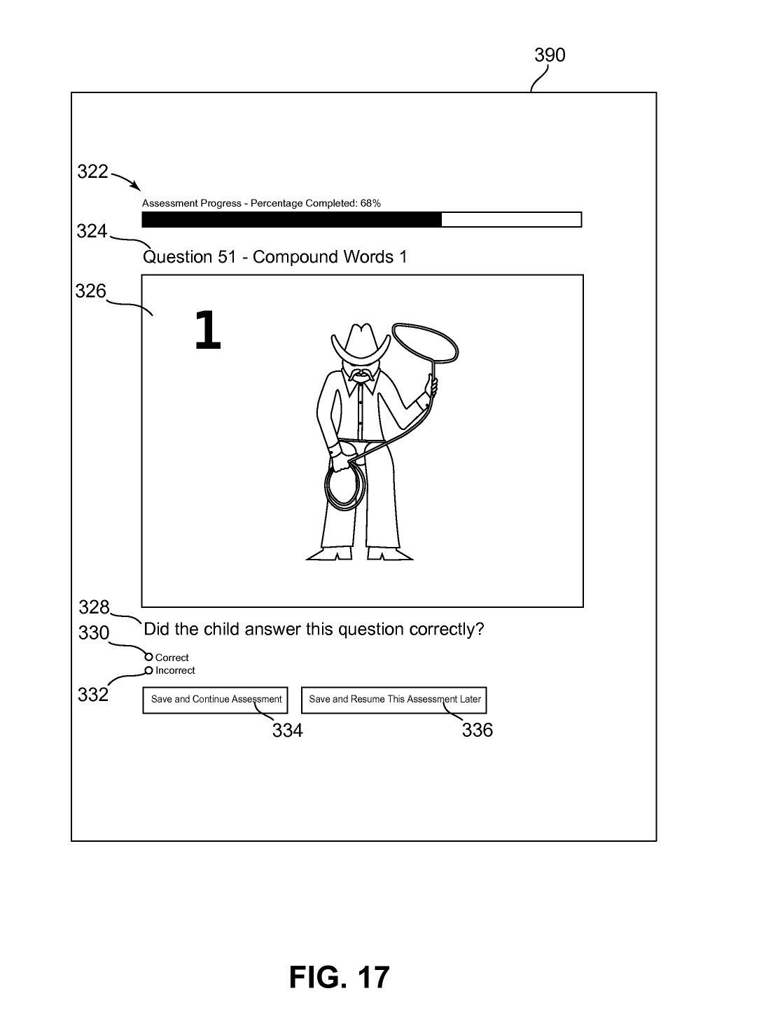

The compound words assessment 256 presents one or more questions that evaluate a child's ability to identify portions of compound words. An example of the compound words assessment 256 is described with reference to FIG. 17.

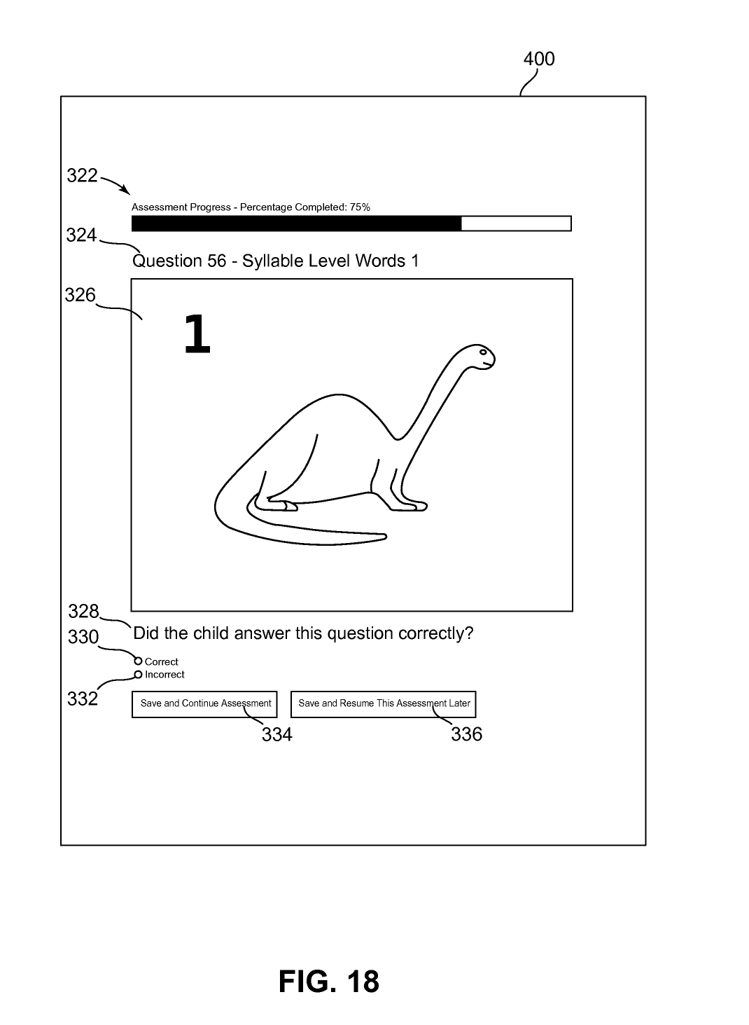

The syllable level words assessment 258 presents one or more questions that evaluate a child's ability to identify syllables within words. An example of the syllable level words assessment is described with reference to FIG. 18.

The sound identification assessment 248 presents one or more questions that evaluate a child's ability to identify certain sounds. In this example, the sound identification assessment 248 includes two subsections, including a first sounds assessment 260 and a last sounds assessment 262. The first sounds assessment 260 asks a child to identify two words that start with the same sound. The last sounds assessment 262 asks the child to identify two words that end with the same sound. Examples of the first and last sounds assessments 260 and 262 are described with reference to FIGS. 19-20.

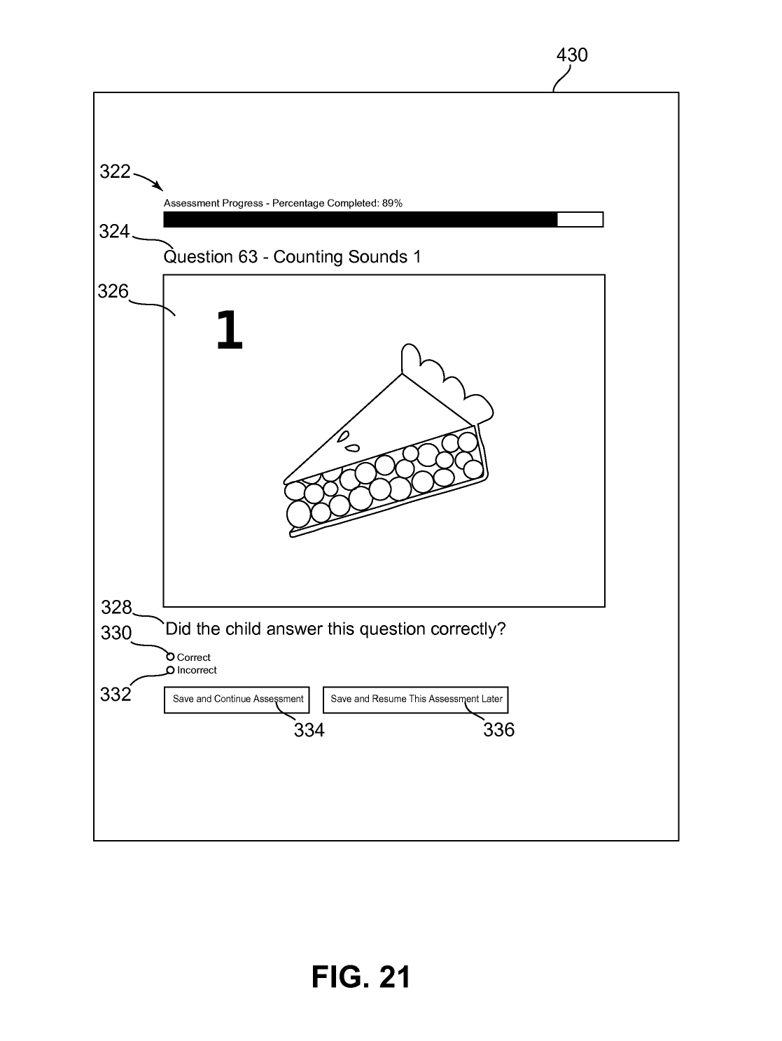

The counting sounds assessment 264 presents one or more questions that evaluate a child's ability to identify individual sounds within a word. An example of the counting sounds assessment 264 is illustrated and described with reference to FIG. 21.

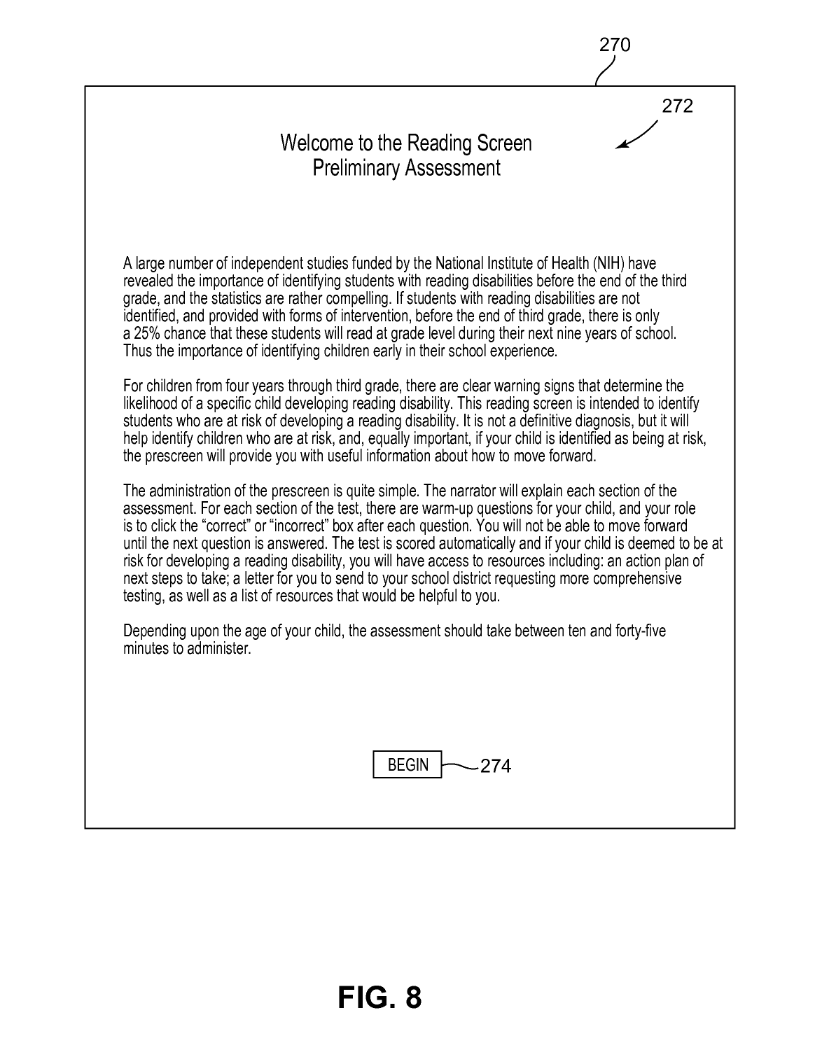

FIG. 8 is a screen shot of an example welcome page 270 of an example of the preliminary assessment 240. In this example, the welcome page 270 includes basic information 272 and a begin control 274.

The basic information 272 presents basic information about the preliminary assessment 240 to the adult A1, such as to help the adult determine whether or not to utilize the preliminary assessment 240 with the child C1. In some embodiments, the basic information provides a short overview of how the preliminary assessment 140 works, an explanation of how the results will be useful, and what the next steps might be after the preliminary assessment 140 is completed.

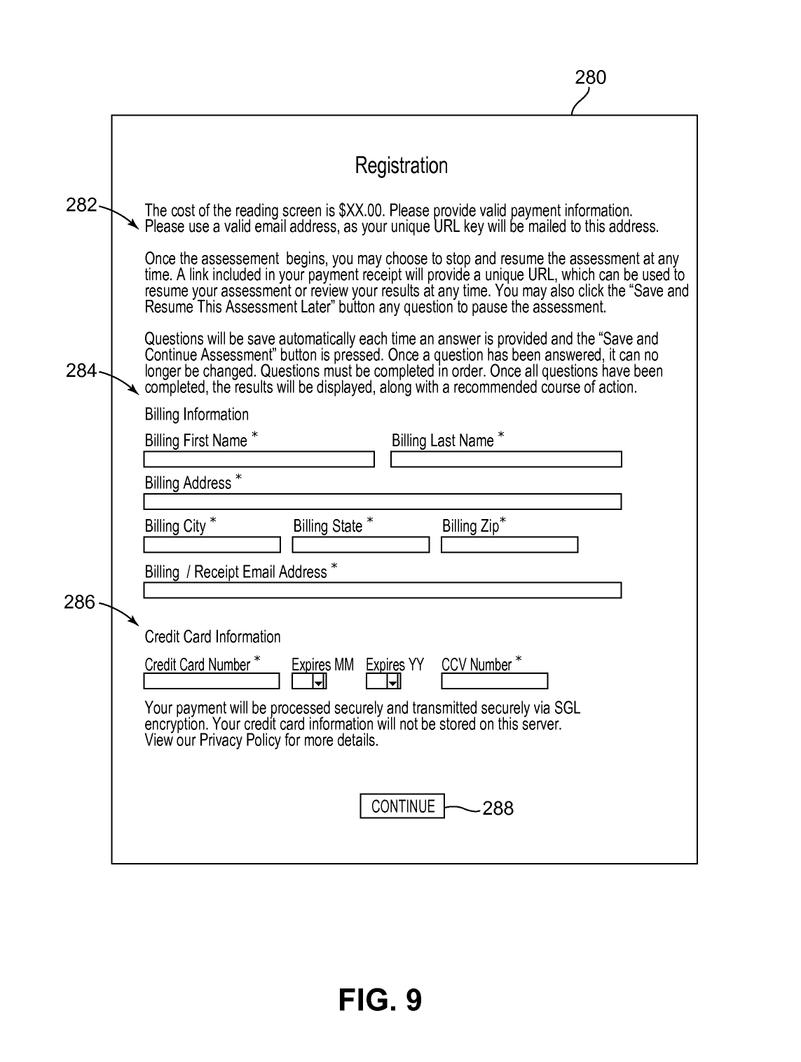

If the adult A1 would like to proceed, the begin control 274 is selected to proceed to a registration page shown in FIG. 9. In this example the begin control 274 is a selectable button.

FIG. 9 is a screen shot of an example registration page 280 of the example preliminary assessment 240. The registration page 280 is provided to register a new user, and in some embodiments, to collect payment information. In this example, the registration page 280 includes registration instructions 282, a billing information entry region 284, a credit card information entry region 286, and a continue control 288.

The registration instructions 282 provide instructions for the completion of the registration page 280.

The billing information entry region 284 includes fields that prompt the adult A1 to enter billing information, such as first and last name, address, city, state, zip code, and e-mail address. In some embodiments a link is subsequently sent to the adult A1 at the e-mail address. The link permits the adult A1 to return to the preliminary assessment or associated results when desired.

The credit card information entry region 286 prompts the adult A1 to enter credit card payment details, such as a credit card number, expiration date, and credit card verification number.

Upon completion of the registration page, the adult A1 selects the continue control 288 to begin the assessment. Upon selection of the continue control, the screening system 120 confirms the credit card information, such as by sending the information to a third party payment processor for verification. When successfully processed, the screening system 120 proceeds with the preliminary assessment. Additionally, at least some of the registration information is stored in the user data 214 shown in FIG. 4.

FIG. 10 is a screen shot of an example history assessment page 302. In this example, the history assessment page includes a child name prompt 304, child age prompt 306, and history questions 308. The child history assessment page 302 is an example of the history assessment 242 discussed with reference to FIGS. 6 and 7.

The child name prompt 304 prompts the adult A1 to enter the name of the child C1 to be assessed. The child's C1 name is then entered and stored in the user data 214 as the name 220, shown in FIG. 4. The child's name is then used as a unique identifier to subsequently identify the assessment and results. For example, if multiple children are to be assessed, a unique name is entered for each child to allow the adult A1 to distinguish between the multiple assessments and results.

The child age prompt 306 is provided to prompt the adult A1 to enter the child's C1 age. In this example the child age prompt 306 prompts for the age in terms of years and months. In another possible embodiment the child age prompt 306 prompts only for the child's age in years. In yet another possible embodiment, the child's birthday is input to permit the screening system 120 to compute the child's C1 age. The age is then stored as the age 222 of the user data 214, shown in FIG. 4.

The history questions 308 are also presented. In some embodiments, the number of history questions 308 (as well as the number of questions presented in other sections discussed herein) varies depending on the age of the child C1 identified in the age prompt 306. For example, if a child is less than 7 years old, only the first four questions are asked. If the child is 7 years old or older, all nine questions are asked. Other embodiments include additional, fewer, or different questions.

A child's history with respect to a reading disability is a very important consideration as to whether or not the child will develop a reading disability. For example, if there is a family history of a reading or spelling disability, there is a strong risk that the child will develop a reading disability. Various other factors should also be considered. The importance of such factors can be divided into three tiers, from a first tier of greatest relevance to a third tier of lesser relevance. Factors in the first tier include whether there is a family history of a reading or spelling disability, whether the child was slow to develop oral language, whether the child has difficulty reciting the alphabet, and whether the child could identify the letters of the alphabet by the end of kindergarten. Second tier factors include whether the child has difficulty playing with words or language, and whether or not the child had difficulty learning to read in his or her early school years. Third tier factors include whether the child is interested in books, whether the child's behavior changed when he or she started school, and whether or not the child has difficulty with the sequence of the seasons of the year.

Another factor that is considered in some embodiments is a history of physical impairment, such as a visual impairment. Therefore, in some embodiments a question is presented asking whether the child has been diagnosed with a physical impairment. Additionally, the history assessment can remind the adult A1 that if a visual impairment has been identified and glasses have been prescribed, is the child currently wearing the prescription glasses? If not, the visual impairment may have an adverse impact on the test results.

In one example, the history questions 308 include the following:

(1) Is there a family history of a reading disability?

(2) Was your child slow to develop oral skills?

(3) Does your child have difficulty playing with words or language (for example, rhyming, making up stories, reciting nursery rhymes, etc.)?

(4) Is your child not interested in books—even being read to?

(5) Did your child have difficulty learning to read in his/her early school years?

(6) Did your child's behavior change when he/she started school?

(7) Does your child have difficulty reciting the alphabet?

(8) Does your child have difficulty with the sequence of the seasons of the year?

(9) Could your child identify the letters of the alphabet by the end of kindergarten?

In this example, each of the history questions 308 is followed by a result prompt, which allows the adult to answer yes 310 or no 312 to each question.

After all questions have been answered, the continue control 314 is selected to proceed to the next section.

FIG. 11 is a screen shot of an example spatial understanding assessment page 320. The spatial understanding assessment page 320 presents a question to evaluate a child's spatial understanding. In this example, the spatial understanding assessment page 320 includes a progress bar 322, a question identifier 324, a question presentation window 326, a result prompt 328 with result controls 330 and 332, a save and continue control 334, and a save and exit control 336. The spatial understanding assessment page 320 is an example of a question that can be presented by the spatial understanding assessment 252, shown in FIG. 7.

In some embodiments the progress bar 322 is presented on some or all of the assessment pages to graphically display the current assessment status as a percentage of the overall assessment that has been completed. The progress bar 322 allows the adult A1 to easily visualize how much progress has been made and how much of the assessment remains. In some embodiments the progress is also shown numerically as a percentage (e.g., 1% completed).

The question identifier 324 is presented to identify the current section of the assessment and the question number. For example, the question identifier identifies the question by a question number (“Question 1”), and also identifies the current section of the assessment as the “Spatial Understanding” section.

The page 320 includes a question presentation window 326 in which a video associated with this question can be displayed to the child C1. In some embodiments, the page 320 causes the computing device 122 to load a video player. The video player accesses the video file 216 (FIG. 4) associated with the current question. The video player includes player controls, such as play and stop buttons. Some embodiments include volume controls. Such controls are hidden during playback, but can be made visible by clicking on the question presentation window 326, for example. When the child C1 is ready, the adult A1 begins the video by providing a suitable input into the spatial understanding assessment page 320.

Because this is the first question of the section on spatial understanding, the video provides instructions to the child before presentation of the first question.

As one example, the video presents the following instructions: “In this first part we are going to be looking at a table and a kitten. The kitten likes to move around, so what you are going to do, is decide just where the kitten is when it's around the table.” The graphic shown in FIG. 11 of a kitten on a table. The first question is then presented to the child: “Is it on the table, over the table, under the table, or next to the table?”

The child C1 answers the question to the adult A1, who determines whether or not the child C1 answered correctly, as prompted by the result prompt 328. The adult A1 then indicates whether or not the child answered correctly by providing the appropriate input into the result controls 330 (yes) or 332 (no).

Upon completion of the question, the adult selects the save and continue control 334 to advance to the next question or the save and exit control 336 to exit the assessment.

Additional questions are then asked in the same manner until the spatial understanding section has been completed.

Additional pages are described with reference to FIGS. 12-21, which include the same layout as the example page shown in FIG. 11. For example, they similarly contain the progress bar 322, the question identifier 324, the question presentation window, the result prompt 328 with the result controls 330 and 332, the save and continue control 334, and the save and exit control 336. Accordingly, the descriptions of such page features are not separately repeated below. Additionally, other embodiments may have different layouts than the examples illustrated herein.

FIG. 12 is a screen shot of an example rhyming assessment page 340. The rhyming assessment page 340 presents a question to evaluate the child's ability to identify words that rhyme. The rhyming assessment page 340 is an example of a question that can be presented by the rhyming assessment 244, shown in FIG. 7.

In this example, the question identifier illustrates an example of Question 5, which begins the Rhyming Section A-1. Because this is the first question in the next section, the video played in the question presentation window 326 first presents instructions for answering the question. An example of the instructions is as follows: “Now we'll do some rhyming. Here in Section A, we'll show you four pictures. All you have to do is pick out the thing that rhymes with the thing shown in the first picture. Words that rhyme end with the same sound, like hat and cat.”

The video then provides a couple of examples, as follows, with matching graphical images: “Let's do one for practice. I'll tell you what each thing is, and then you say it after me. Here we go. This is a box. Say box. Very good. Now I'll show you three more things and we'll figure out which one rhymes with box. Remember, words that rhyme end with the exact same sound. This is a fan. Say fan. Fan. This is the sun. Say sun. Sun. And this is a fox. Say fox. Fox. So, we have a fan, the sun, and a fox. Which one rhymes with box? Fox. Fox rhymes with box, because they both end with the ‘ox’ sound. See how easy this is?”

Next, the first question is presented: “Let's do a few more and you can decide which things rhyme? This is a cat. Say cat. Cat. Which one rhymes with cat? This is a cup. Say cup. Cup. This is a hat. Say hat. Hat. This is a mit. Say mit. Mit. So we have a cup, a hat, and a mit. Which one rhymes with cat?”

The adult A1 then listens to the answer provided by the child C1 and determines whether or not the child C1 correctly identifies the hat as the word that rhymes with cat, and indicates accordingly into the result controls 330 or 332.

Additional questions are presented in some embodiments until the section has been completed.

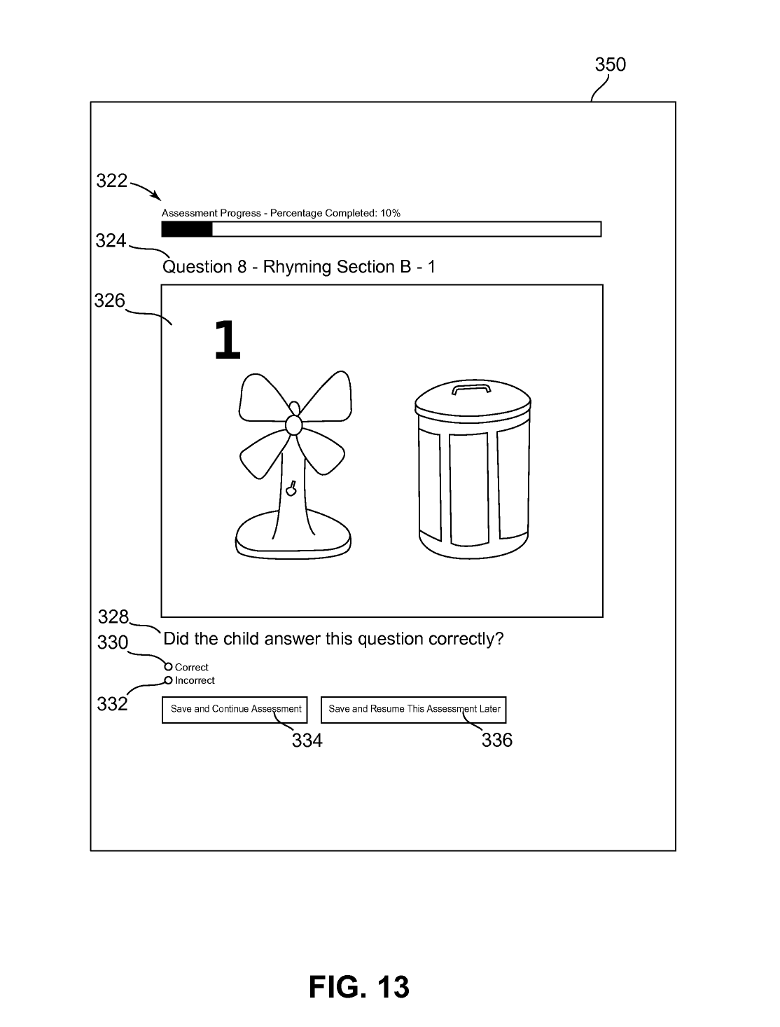

FIG. 13 is a screen shot of another example rhyming assessment page 350. In this example, the rhyming assessment page 350 provides another example of a question that can be presented by the rhyming assessment 244, shown in FIG. 7.

In this example, the video presents the following instructions for this second section of the rhyming assessment: “Very good. Now on to section B for some more rhyming. Here in section B we are going to show you things two at a time. All you have to do is say whether or not they rhyme.”

The video then provides several examples, with matching graphics: “First we'll do a couple to warm up and I'll tell you what they are, and we'll decide together whether or not they rhyme. Remember two words rhyme if they end with the same sound. Like goat and boat, and bear and pear. Here we go. This is a hat and this is a rat. Rat and hat. Do rat and hat rhyme? Yes they do. They both end with the ‘at’ sound. R-at and h-at do rhyme. Let's try another one just for practice. This is a pig and this is a dog. Pig and dog. Do pig and dog rhyme? No they don't rhyme. They don't rhyme because pig ends with an ‘ig’ sound (p-ig) and dog ends with an ‘og’ sound (d-og). Ig and og don't rhyme, so the answer here is no, pig and dog don't rhyme.”

The video then presents the question: “Now I'll show you two things at a time, tell you what they are, and you can decide if they do rhyme or if they don't rhyme. Here we go. This is a fan and this is a can. Fan and can. Do fan and can rhyme? Yes, or no?”

The child C1 answers the question and the adult indicates whether or not the child C1 correctly indicated that, yes, the words fan and can do rhyme.

Additional questions are presented in some embodiments until the section has been completed.

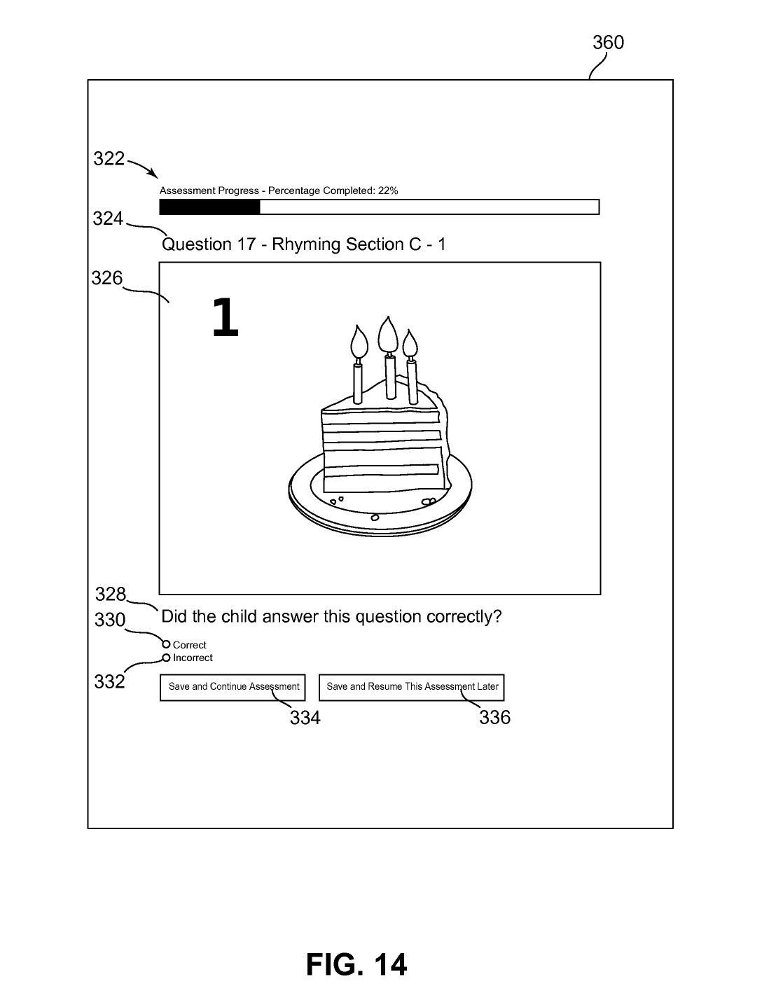

FIG. 14 is a screen shot of another example rhyming assessment page 360. In this example, the rhyming assessment page 360 provides another example of a question that can be presented by the rhyming assessment 244, shown in FIG. 7.

In this example, the video presents the following instructions for this third section of the rhyming assessment: “You are doing very well here. Remember, being right or wrong isn't the important thing. Just by doing your best you are doing it exactly right, okay? Now for just one more bit of rhyming. Remember words that rhyme end with the same sound like cat and hat or pear and bear. Now I'm going to show you some things and you say a word that rhymes. It doesn't even have to be a real word, it just has to rhyme.”

The video then presents the question: “Ready? Here we go. This is a cake. Say ‘cake.’ Now, say a word that rhymes with cake.”

The child C1 then answers the question, and the adult A1 determines whether or not the answer is a word that rhymes with cake. An example of a word that rhymes with cake is make. The adult A1 then selects an appropriate result from controls 330 and 332.

Additional questions are asked in some embodiments, until the section has been completed.

FIG. 15 is a screen shot of an example letter recognition assessment page 370. In this example, the letter recognition assessment page 370 presents a question that evaluates the child's C1 ability to recognize letters of the alphabet. The letter recognition assessment page 370 provides an example of a question that can be presented by the letter recognition assessment 246, shown in FIG. 7.

In this example, the video presents the following instructions for the letter recognition section: “In this section we'll show you a bunch of letters one at a time and you just say what the letter is as it comes up on the screen.”

The video then asks the first question, by displaying the letter “c.”

If the child C1 recognizes the letter, the child C1 answers the question by identifying the letter as the letter “c.” The adult A1 then indicates whether or not the child has answered correctly by selecting one of controls 330 or 332.

Additional questions are asked in some embodiments until the section has been completed. Preferably the order in which the letters are presented is not in alphabetical order. Recognition of some or all of the letters of the alphabet can be tested in this section.

FIG. 16 is a screen shot of an example counting words assessment page 380. The counting words assessment page 380 is used to evaluate a child's ability to distinguish individual words within a phrase. The counting words assessment page 380 provides an example of a question that can be presented by the counting words assessment 254, shown in FIG. 7.

In this example, the video presents the following instructions for this counting words section of questions: “Now we're going to count the number of words in some sentences. It's easy. I'll tell you some sentences and you count the number of words in each one. We'll clap our hands one time for each word in a sentence, and whoever is helping you can count the claps for you.”

The video then provides a couple of examples: “We'll try a couple to warm up. I'll say a sentence and you say it after me. Then we'll say it again, and clap your hands one time for each word. It will go like this. I like birthday cake. Now you say it with me. I like birthday cake. Now we'll clap our hands one time for each word in the sentence. I [clap] like [clap] birthday [clap] cake [clap]. This sentence has four words, so we clapped our hands four times. Let's try one more. Dogs like bones. Now say it with me. Dogs like bones. Now we'll clap our hands one time for each word in the sentence. Dogs [clap] like [clap] bones [clap]. This sentence has three words, so we clapped our hands three times.”

The video then presents the question: “Now I'll say a sentence and then you say it with me. Then, you say it by yourself and clap your hands one time for each word, like we just did. The first sentence is we eat popsicles. Now you say we eat popsicles and clap your hands one time for each word. Whoever is helping you will count the number of times that you clap.”

The child C1 then answers the question and the adult counts the number of times that the child C1 claps his or her hands, to see if the child C1 correctly claps his hands three times. The adult A1 records the result into one of the controls 330 or 332.

Additional questions are then asked in some embodiments until the section has been completed.

FIG. 17 is a screen shot of an example compound words assessment page 390. The compound words assessment page 390 is used to evaluate a child's ability to distinguish parts of a compound word from its other parts. The compound words assessment page 390 provides an example of a question that can be presented by the compound words assessment 256, shown in FIG. 7.

In this example, the video presents the following instructions for the compound words section: “In this next part I'm going to show you some pictures of things and say what they are. Then you say them with me. After we've said them, I'll ask you to say the same word, but with a part of the word left out.”

The video then presents several examples: “We'll do a couple together first, to help you get started. This is popcorn. Say “popcorn.” Popcorn. Now let's say popcorn without saying the “pop” part. Popcorn without the pop is corn. So the answer is corn. Now let's try one more. This is a strawberry. Say strawberry. Strawberry. Now let's stay strawberry without the berry part. Strawberry without the berry is straw. So the answer is straw.”

The video then presents the first question: “Okay, now you do a few on your own. This is a cowboy. Say cowboy. Cowboy. Now say cowboy without saying the boy part. Say cowboy again, but leave off the boy part.”

The adult A1 determines whether or not the child C1 correctly answers with the word “cow,” and provides the appropriate result into the control 330 or 332.

Additional questions are asked in some embodiments until the section has been completed.

FIG. 18 is a screen shot of an example syllable level words assessment page 400. The syllable level words assessment page 400 is used to evaluate a child's ability to identify syllables within a word. The syllable level words assessment page 400 provides an example of a question that can be presented by the syllable level words assessment 258, shown in FIG. 7.

In this example, the video presents the following instructions for the syllable level words section: “In this next part I'm going to show you some more pictures of things and say what they are. Then you say them with me. After we've said them, I'll ask you to say the same word but with a part of the word left out.”

The video then presents a couple of examples: “We'll do a couple together first to help get you started. This is a cucumber. Say cucumber. Cucumber. Now let's say cucumber without saying the ‘cu’ part. Cucumber without the cu is cumber. So the answer is cumber. Let's try one more. This is a kangaroo. Kangaroo. Now, let's say kangaroo without saying the ‘roo’ part. Kangaroo without the roo is kanga. So the answer is kanga.

The first question is then presented: “Okay now you get to do a few more on your own. This is a dinosaur. Say dinosaur. Dinosaur. Now say dinosaur without saying the dino part. Say dinosaur without saying the dino part.”

The child C1 answers the question and the adult Al determines whether the child C1 has correctly says “saur.” The adult Al responds accordingly into control 330 or 332.

Additional questions are asked in some embodiments until the section has been completed.

FIG. 19 is a screen shot of an example first words assessment page 410. In this example, the first words assessment page 410 is used to evaluate whether the child C1 can identify words that begin with the same sound. The first words assessment page 410 provides an example of a question that can be presented by the sound identification assessment 248, and more specifically the first sounds assessment 260, shown in FIG. 7.

In this example, the video presents the following instructions for the first sounds section: “Now we're going to look at some things and decide which ones start with the same sound as the first thing. We're not looking for the first letter here, we're looking for the first sound.”

The video then provides an example: “Let's do one together first and I'll say what each thing is, and then you say what it is. Here we go. This is the sun. Say sun. Sun. Now I'll show you four more things and we'll figure out which ones start with the same sound as sun. Remember we're looking for words that start with the same sound as sun. This is a ball. Say ball. Ball. This is a sock. Say sock. Sock. This is a smile. Say smile. Smile. This is a cat. Say cat. Cat. So we have a ball, a sock, a smile, and a cat. Which ones begin with the same sound as sun? It's the sock and the smile. Sock and smile both start with the s sound, just like sun. So the answer is sock and smile sound with the same sound as sun. See how easy this is?”

The video then presents the first question: “Let's do a few more and you can decide which things start with the same sound as the first thing. This is cake. Say cake. Cake. Find the ones that sound with the same sound as cake. Cake. Cake. This is boat. Say boat. Boat. This is a king. Say king King. This is a hat. Say hat. Hat. And this is a car. Say car. Car. So we have a boat, a king, a hat, and a car. Which ones start with the same sound as cake?”

The adult A1 listens to determine whether the child C1 correctly identifies the king and the car as both starting with the same sound as cake. The adult A1 indicates the result in one of the controls 330 or 332.

Additional questions are then asked in some embodiments until the section has been completed.

FIG. 20 is a screen shot of an example last sounds assessment page 420. In this example, the last sounds assessment page 420 is used to evaluate whether the child C1 can identify words that end with the same sound. The last sounds assessment page 420 provides another example of a question that can be presented by the sound identification assessment 248, and an example of a question presented by the last sounds assessment 262, shown in FIG. 7.

In this example, the video presents the following instructions for the last sounds section: “Now we're going to look at some things and decide which ones end with the same sound as the first thing. We're not looking for the last letter here. We're looking for the last sound.”

The video then provides an example: “Let's do one together first. I'll say what each thing is, and then you say what it is. This is a cat. Say cat. Now I'll show you four more things and we'll figure out which ones end with the same sound as cat. Remember we're looking for words that end with the same sound as cat. This is the sun. Say sun. Sun. This is a boat. Say boat. Boat. This is a bar of soap. Say soap. Soap. And this is a heart. Say heart. Heart. So we have the sun, a boat, a bar of soap, and a heart. Which ones end with the same sound as cat? It's the boat and the heart. Boat and heart both end with the ‘t’ sound, just like cat. So the answer is that boat and heart both end with the same sound as cat.”

The video then presents the first question: “Let's do a few more and you can decide which things end with the same sound as the first thing. This is a bug. Say bug. Bug. Find the ones that end with the same sound as bug. This is a car. Say car. Car. This is a dog. Say dog. Dog. This is a bed. Say bed. Bed. This is a pig. Say pig. Pig. So we have a car, a dog, a bed, and a pig. Which ones end with the same sound as bug?

The adult A1 determines whether the child C1 correctly identifies dog and pig as ending with the same sound as bug, and inputs the result into controls 330 or 332.

Additional questions are asked in some embodiments until the section has been completed.

FIG. 21 is a screen shot of an example counting sounds assessment page 430. The counting sounds assessment page is used to evaluate the child's C1 ability to identify individual sounds within a word. The counting sounds assessment page 430 provides an example of a question that can be asked by the counting sounds assessment 264, shown in FIG. 7.

In this example, the video presents the following instructions for the counting sounds section: “In this last part we are going to count the number of sounds in some words. Not the number of letters, the number of sounds. We'll show you some pictures and I'll say what they are, then you say it with me just so you're sure. Once we're sure what the picture is, you say the word yourself and clap your hands one time for each sound in the word. Like when we counted words, only this time we're counting the number of sounds in one word at a time.”

The video then provides several examples: “Let's try a few to warm up. Okay? This is an eye. Say eye. Eye. Now let's clap our hands one time for each sound in the word eye. Eye [clap]. Eye has one sound so we clap our hands one time. Let's try another one. First, let's turn this light on. There. The word is on. Say on. On. Now let's clap our hands one time for each sound in the word on. Ah [clap] nn [clap]. The word on has two sounds ah—nn, so we clapped our hands twice. Next let's try the word pig. Say pig. Pig. Now let's clap our hands one time for each sound in the word pig. P [clap] ih [clap] g [clap]. The word pig has three sounds, p—ih—g, so we clapped our hands three times.”

The video then presents the first question: “Now it's your turn to count some sounds on your own. I'll show you some things and say what they are. Then you say it with me. Then you say the word yourself and clap one time for each sound in the word. Just do your best and that will be perfect. Whoever is helping you will count the number of times you clap. This is a pie. Say pie. Pie. Now say pie and clap one time for each sound in the word pie.”

The adult then determines whether the child C1 correctly identifies that there are two sounds in the word pie, and indicates the result with controls 330 or 332.

Additional questions are asked in some embodiments until the section has been completed.

That concludes the presentation of questions in this example embodiment of the preliminary assessment, as presented by the assessment engine 132, shown in FIG. 2.

FIG. 22 is a flow chart illustrating an example method 440 of scoring a preliminary assessment. In some embodiments, the method 440 illustrates the operation of an example scoring engine 134, shown in FIG. 2. In this example, the method 440 includes operations 442 and 444.

The operation 442 is first performed to determine a total number of questions in the preliminary assessment. In some embodiments this is a fixed number. In other embodiments, the total number of questions varies. For example, as discussed with reference to FIG. 5, in some embodiments the number of questions asked varies depending on the child's C1 age. For example, a child C1 four years old or younger may be asked 60 questions, a five year old child C1 may be asked 85 questions, and a child six year old or older may be asked 161 questions. Other embodiments have other quantities of questions. In some embodiments the quantities can change based on other factors, such as whether or not the child gets certain questions right or wrong.

The operation 444 is performed to determine a total number of incorrect responses and to subtract that number from the total number of questions identified in operation 442. The result of the operation 444 is a raw score for the preliminary assessment.

Other scoring algorithms are used in other embodiments. For example, in some embodiments weighting factors are applied to certain questions or to certain sections to weight certain answers more heavily than others.

In other embodiments, however, the number of questions presented in each section automatically provides a weighting factor in the scoring of each section (e.g., if a child struggles with letter identification, the number of incorrect answers given is likely to be twice as high if twice as many questions are asked in that section. Therefore, by increasing the number of questions in a section with respect to other sections, the impact of that section on the overall score can be increased).

FIG. 23 is a flow chart illustrating an example method 450 of generating a recommendation based on a preliminary assessment of a risk of developing a learning disability. The method 450 also illustrates the operation of an example of the recommendation engine 136, shown in FIG. 2. In this example, the method 450 includes operations 452, 454, 456, 458, 460, 462, and 464.

The operation 452 is performed to identify a risk level based on a score. One example of the score is the raw score discussed with reference to FIG. 22.

In some embodiments, the operation 452 uses the score to identify a risk level by comparing the raw score with predetermined values. An example of a lookup table identifying the predetermined values is shown in Table 1.

TABLE 1

| Age-Based Risk | 4 YEARS | | | |
|---|---|---|---|---|
| Levels Based | OR | | | |
| on Raw Scores | YOUNGER | 5 YEARS | 6 YEARS | 7+ YEARS |
| Low Risk | 60 | 85 | 161 | 161 |
| Moderate Risk | 58 to 59 | 81 to 84 | 154 to 160 | 158 to 160 |
| High Risk | 57 or | 80 or | 153 or | 157 or |
| | lower | lower | lower | lower |

Using this lookup table, the operation 452 first identifies the age of the child C1 that has been scored. The score obtained on the preliminary assessment is then compared with the identified risk levels to identify a risk level associated with that score. For example, a 5 year old child that scores 82 would be identified as being in the moderate risk level.

As can be seen, the expected scores on the assessment increase with age. This represents the expectation that children's reading skills continue to develop as they get older. As a result, even if 6 and 7 year old children take the same preliminary assessment having 161 total points possible, the 6 year old that scores a 155 will only be found to be at a moderate risk level, while a 7 year old with the same score will be found to be at a high risk level.

Therefore, the operation 452 uses the score to classify the child as having a low risk in the operation 454, a moderate risk in the operation 456, or a high risk in the operation 458 of developing a reading disability.

If a child is determined to have a low risk in the operation 454, a recommendation 460 is presented to the adult Al advising the adult of the low risk and providing additional information. As one example, the recommendation is as follows: “Congratulations! At the present time, your child is not showing signs of developing a reading disability. To be sure he or she continues to stay on track, we recommend reassessing the child again in one year. To do so, please save your username and password so that you can access the Reading Screen again at no charge.”

If the child is determined to have a moderate risk in operation 456, a recommendation 462 is presented to the adult A1 advising the adult A1 of the moderate risk and providing additional information. As one example, the recommendation is as follows: “Your child scored in the moderate risk range. We recommend reassessing the child again in six months.”

If the child is determined to have a high risk in operation 458, a recommendation 464 is presented to the adult A1 advising the adult A1 of the high risk and recommending a formal evaluation. In some embodiments the recommendation 464 also provides additional information. As one example, the recommendation is as follows: “Your child scored in the high risk range. We recommend that your child undergo a more thorough evaluation to determine whether he/she had a reading disability.”

Other embodiments of the recommendation engine 136 identify different risk levels. For example, in some embodiments the recommendation engine 136 uses the score to determine whether the child C1 is likely to develop a reading disability or is unlikely to develop a reading disability. In yet other embodiments, the risk can be divided into multiple different levels of severity. Further, in some embodiments results are displayed based on the different sections of the test, such as to identify the particular area or areas of weakness for the child. In some embodiments the results for each question are provided to permit the adult A1 and or another professional (e.g., the speech and language professional S1, director of special education P1, or teacher T1) to evaluate the results to determine the formal assessments and therapies that may be appropriate for the child C1.

FIG. 24 is a flow chart illustrating an example method 470 of providing resources relating to a preliminary assessment of a risk of developing a reading disability. The method 470 also illustrates an exemplary operation of the resource generator 138, shown in FIG. 2. In this example, the method 470 includes the operations 472, 474, 476, 478, 480, 482, 484, and 486.

The operation 472 is performed to determine the risk level identified for the child C1. In some embodiments the risk level is determined using a score, as discussed with reference to FIG. 23. In this example the risk level is identified as either a low risk in the operation 474, a moderate risk in the operation 476, or a high risk in the operation 478.

If the risk level is determined to be a low risk, the operation 480 is performed in which case a determination is made that no additional resources are needed, because the child C1 is not likely to develop a reading disability, and therefore there should be no need for any further formal assessment or treatment.

If the risk level is determined to be a moderate risk in the operation 476 or a high risk in the operation 478, then additional resources are provided. In this example, additional resources are provided in the operations 482, 484, and 486.

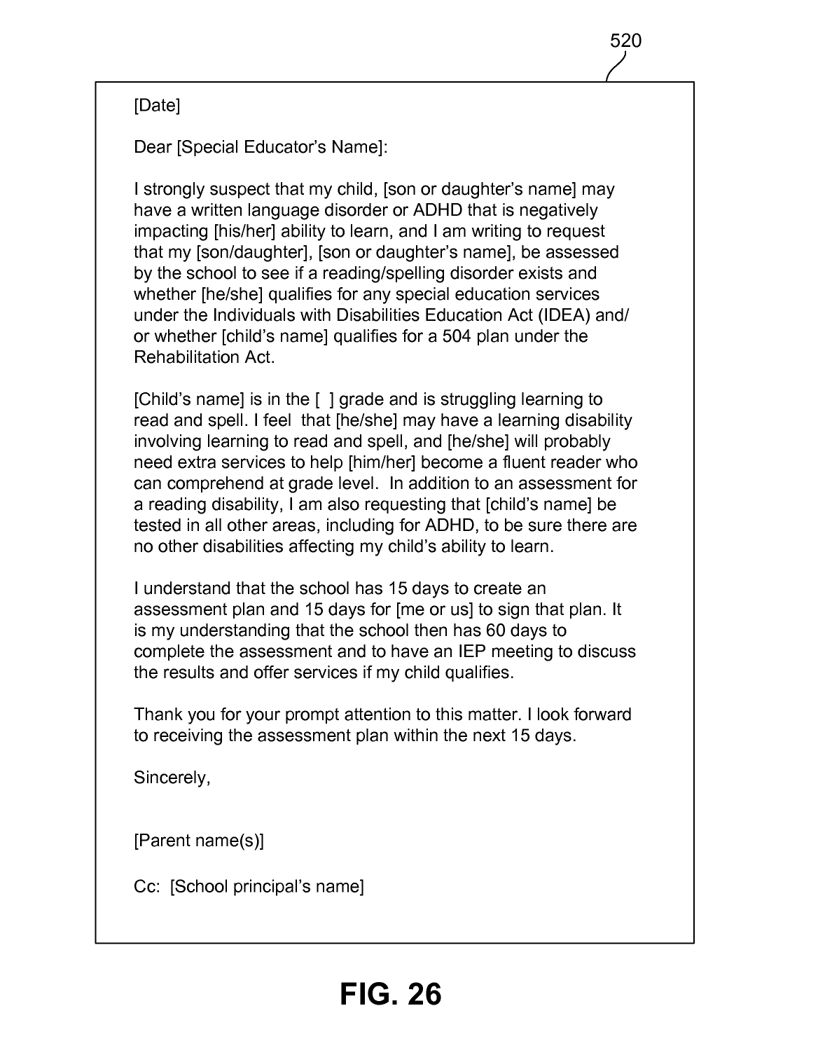

The operation 482 provides a letter that can be sent to the director of special education P1 or school district requesting a formal evaluation by the local public school. In some embodiments the letter is a template or form that contains key language that, if sent to the school or school district, requires prompt action on their part, as defined by law. For example, in the United States a law titled the Individuals with Disabilities Act was reauthorized and signed into law in 2004. When triggered, the law defines specific actions and strict timelines that must be complied with by the schools or school districts. The letter provided in the operation 482 is drafted in such a way as to trigger these actions and timelines. One example of such a letter is illustrated and described in more detail with reference to FIG. 26.

For example, the law currently requires that, once the letter from a parent is received from the school or school district, the school has 15 days to present an assessment plan to the parent that requested it. The parent then has 15 days to sign off on the plan or to offer revisions to the plan. Once the plan has been signed off on by the parent, the school has 60 days to complete a formal assessment and have an Individual Education Plan (IEP) meeting to discuss the results of the assessment and offer services that the child may qualify for. The IEP meeting will include members of the IEP team, including the special education director, the child's teacher(s), the parents, the special education teacher(s), and any specialists such as a speech and language therapist or an occupational therapist. Once concluded, the IEP will be written detailing the specific goals and objectives that the child's C1 teachers will be helping the child C1 to meet during the course of the school year. Follow up achievement tests may also be planned to ensure that the child C1 is making adequate progress according to the plan. Annual IEP meetings should also be scheduled thereafter to develop an IEP plan for the following year, or to determine that additional treatment is no longer required.

The operation 484 provides a special education roadmap. The special education roadmap is a written document that provides guidance relating to reading disabilities. The written document includes, for example, a brief overview of the laws and process discussed above, and answers commonly asked questions. In one example, the roadmap answers the following questions: 1) what can I do to help my child obtain the education that he deserves, 2) what is a reading disability, 3) are there signs to look for in children who may develop a reading disability, 4) what should I do if I suspect my child has a reading disability, 5) what should I do after my child has been evaluated, 6) what should I do if my child has qualified for services, and 7) what should we be looking for once my child has qualified for services.

The operation 486 provides references to additional resources. In one example, the references to additional resources is a list of other resources that may be helpful to the adult A1. The resources can include, for example, a list of books or web sites that provide additional information regarding reading disabilities, the names of clubs or organizations that provide support for families having a child with a reading disability, links to governmental resources relating to reading disabilities, information about schools that specialize in helping students with reading disabilities, and information on therapeutic curriculum and training resources for addressing issues associated with reading disabilities.

If the child C1 is determined to have a moderate risk, the additional resources may be presented as optional resources that are presented in case the adult A1 want to pursue formal assessment or treatment at this time. As one example, the following message is also displayed to the adult A1: “Should you wish your child to undergo a more thorough evaluation, we have provided a letter that can be individualized for your child. This letter, requesting a formal psycho-educational evaluation from the school district, should be sent via certified mail to the special education director of your child's public school. Also attached is a special education roadmap with a series of the most often asked questions along with answers to these questions. Please read this roadmap before beginning the process of requesting testing from the school. You may wish to refer to the roadmap often during your journey through the special education process. Finally, attached is a list of resources you might want to avail yourself of.”

If the child C1 is determined to have a high risk, the additional resources are suggested and recommended to the adult A1 for use. As one example, the following message is displayed to the adult A1: “Attached is a letter that can be individualized for your child. This letter, requesting a formal psycho-educational evaluation from the school district, should be sent via certified mail to the special education director of your child's public school. Also attached is a special education roadmap with a series of the most often asked questions along with answers for these questions. Please read this roadmap before beginning the process of requesting testing from the school. You may wish to refer to the roadmap often during your journey through the special education process. Finally, attached is a list of resources you might want to avail yourself of.”

FIG. 25 is a screen shot illustrating an example assessment results page 490. In this example, the assessment results page 490 presents an assessment score 492, name 494 of the child C1, recommendation 496, links 498 to a sample letter, links 500 to a roadmap, links 502 to additional resources, and detailed results 504. In some embodiments the detailed results identify the question numbers 506, a question type 508, a response 510, and a result 512.

In some embodiments the assessment results page 490 is presented at the conclusion of the preliminary assessment. The assessment results page 490 can be presented to the adult A1, and can also be presented to others, such as the director of special education P1, speech and language therapist S1, and the special education teacher T1 in some embodiments. Additionally, in some embodiments the results page 490 may be printed by the adult A1, and the printed results can be provided to others by the adult A1 if desired. In some embodiments, the results page 490 may be saved in an electronic form and shared with others via e-mail, for example.

In this example, the results page 490 presents the score 492 achieved by the child C1 on the assessment. However, in other embodiments the raw score is not usable by the adult A1 in its raw form, and so some embodiments do not present the raw score. The raw score can be converted into another score, such as a percentage of correct answers. In other embodiments, the ranges of scores that are associated with various risk levels can be displayed to permit the adult A1 to see where the raw score falls within the risk levels. An example of the risk levels is shown in Table 1, above.

The name 494 of the child C1 who was assessed is displayed in some embodiments. The name 494 can be used to associate the assessment results with the appropriate child C1 in the event that the printed or saved results are subsequently accessed or viewed.

In some embodiments the assessment results page 490 includes a recommendation 496, that advises the adult A1 on what next steps are recommended based on the preliminary assessment. The recommendation 496 may include, for example, a recommendation 496 that formal testing be performed, and that the adult A1 contact the school district to obtain the assessment and additional assistance. Additional examples of suitable recommendations 496 are described herein, such as with reference to the operations 460, 462, and 464 shown in FIG. 23.

In some embodiments the assessment results page 490 also provides additional resources, such as described with reference to FIG. 24. In this example, the assessment results page 490 includes links 498 to a sample letter, links 500 to a roadmap, and links 502 to additional resources. In some embodiments links are provided to the resources in multiple formats, such as an editable form (e.g., a Word format) and a non-editable form (e.g., a PDF format). The resources can be provided in other formats as well, such as by presenting the results on separate pages.

Some embodiments provide detailed results 504. In this example, the detailed results 504 include a listing of each question number 506, an identification of a type 508 of each question (e.g., history or assessment), an identification of the actual response received (e.g., Yes/No or Correct/Incorrect), and a result 512 (e.g., whether the result was recorded as a correct or an incorrect answer for scoring purposes).

FIG. 26 illustrates an example of a letter 520 to a school or school district requesting a formal assessment of a child C1 found to be at risk of developing a reading disability through the preliminary assessment. In this example, the letter is a template that can be completed by the adult A1. Once the template is complete, the letter can be sent (via mail, e-mail, fax, etc.) to the intended recipient to request a formal assessment. In some embodiments the letter is adequate to trigger a formal process defined by laws or regulations relating to learning disabilities, such as the Individuals with Disabilities Education Act (IDEA), as discussed herein.

Some embodiments, as described herein and such as illustrated in FIG. 1, are utilized by an adult A1 working with a child C1. In some embodiments preliminary assessment is provided to a group of children C1. For example, the preliminary assessment can be administered to a group of children that are in a common school, class, club, or other organization. The preliminary assessment may still be administered to each child individually, for example, but the results may be compiled and considered as a whole. For example, each section of the test may be scored separately and the results averaged across the population to arrive at group scores for each section. These group scores for each section can then be evaluated to identify general areas of weakness that appear within the population of the children in the group. Once this is known, the results could be used to suggest additional formal assessments that may be helpful, or alternatively may identify treatment that is needed within the group, such as a topic of a curriculum that could be provided to the children to assist the children in improving in that area of weakness. In some embodiments the administration of the assessment is provided to the group in the form of a workshop.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of performing a preliminary assessment of a child to evaluate the child's risk of developing a reading disability, the method comprising:
assessing, using at least one computing device, a history of the child to at least identify whether the child has a family history of reading disability;
assessing the child's rhyming ability;
assessing the child's ability to recognize letters of an alphabet;
assessing the child's ability to identify particular sounds; and
using the results of the assessments to evaluate the child's risk of developing a reading disability.

2. The method of claim 1, wherein assessing the history of the child further comprises:
assessing whether the child was slow to develop oral skills;
assessing whether the child has difficulty playing with words or language;
assessing whether the child is interested in books;
assessing whether the child had difficulty learning to read in early school years;
assessing whether the child's behavior changed when the child started school;
assessing whether the child has difficulty reciting the alphabet;
assessing whether the child has difficulty with a sequence of seasons of a year; and
assessing whether the child could identify letters of the alphabet by an end of kindergarten.

3. The method of claim 1, wherein assessing the child's rhyming ability further comprises assessing whether the child can identify two words that end with the same sound.

4. The method of claim 1, wherein assessing the child's ability to recognize letters of the alphabet further comprises presenting a graphical depiction of a letter to the child and determining whether the child can identify the letter.

5. The method of claim 1, wherein assessing the child's ability to identify particular sounds comprises performing a first sounds assessment to determine whether the child can identify two words that start with a same sound.

6. The method of claim 5, wherein assessing the child's ability to identify particular sounds further comprises performing a last sounds assessment to determine whether the child can identify two words that end with a same sound.

7. The method of claim 1, further comprising:
assessing the child's spatial understanding;
assessing the child's ability to distinguish individual words within a phrase;
assessing the child's ability to distinguish parts of a compound word;
assessing the child's ability to identify syllables within a word; and
assessing the child's ability to identify individual sounds within a word

8. The method of claim 1, further comprising:
determining an age of the child;
generate an age-appropriate preliminary assessment by identifying a subset of a complete set of questions appropriate to the child's age; and
presenting the subset of the total set of questions to the child as the preliminary assessment, wherein a quantity of questions presented to an older child is greater than a quantity of questions presented to a younger child.

9. The method of claim 1, wherein using the results of the assessments to evaluate the child's risk of developing a reading disability comprises:
determining a total number of questions presented in the preliminary assessment;
determining a number of incorrect responses; and
generating a score by subtracting a number of incorrect responses from the total number of questions.

10. The method of claim 1, wherein using the results of the assessments to evaluate the child's risk of developing a reading disability comprises:
determining a score for the preliminary assessment;
comparing the score with multiple age-based risk levels; and
identifying the child's risk level.

11. The method of claim 10, wherein the age-based risk levels include a low risk level, a moderate risk level, and a high risk level.

12. The method of claim 11, further comprising:
presenting a recommendation based on the preliminary assessment, the recommendation comprising:
for a low risk level, indicating that the child has a low risk of developing a reading disability;
for a moderate risk level, indicating that the child has a moderate risk level of developing a reading disability and recommending an optional formal assessment; and
for a high risk level, indicating that the child has a high risk of developing a reading disability and recommending a formal assessment.

13. The method of claim 1, further comprising:
providing resources relating to the preliminary assessment of a risk of developing a reading disorder, the resources comprising:
a letter to a school or school district requesting a formal assessment;
a special education roadmap that provides guidance relating to reading disabilities; and
references to additional resources.

14. The method of claim 13, wherein the letter is a template that can be completed by an adult to request that the child be formally assessed, wherein the letter contains content configured to trigger applicability of a law or regulation to begin a process by which the school or school district is required to provide the formal assessment.

15. The method of claim 1, wherein the preliminary assessment is provided in the form of web page data transmitted by a web server to a client computing device, wherein the web server is the at least one computing device that performs the assessments and uses the results of the assessments to evaluate the child's risk of developing a reading disability.

16. The method of claim 1, wherein the preliminary assessment is performed in the absence of a licensed, certified, or professional administrator.

17. A screening system comprising:
a processing device; and
at least one computer readable storage device, the at least one computer readable storage device storing data instructions that when executed by the processing device cause the processing device to generate:
an assessment engine operable to present a preliminary assessment to a child to evaluate the child's risk of developing a reading disability;
a scoring engine operable to determine a score based on the preliminary assessment; and
a recommendation engine configured to generate a recommendation based on the score, wherein the recommendation engine recommends that the child be formally assessed for a reading disability when the score indicates that the child has a high risk of developing a reading disability.

18. The screening system of claim 17, wherein the assessment engine is operable to:
assess a history of the child to at least identify whether the child has a family history of reading disability;
assess the child's rhyming ability;
assess the child's ability to recognize letters of an alphabet; and
assess the child's ability to identify particular sounds.

19. The screening system of claim 17, wherein the at least one computer readable storage device further stores a plurality of video files, wherein the assessment engine utilizes the video files to present the preliminary assessment to the child.

20. The screening system of claim 17, wherein the data instructions further cause the processing device to generate:
a resource generator which provides additional resources associated with the preliminary assessment of a child for a reading disability, the additional resources including:
a letter to a school or school district requesting a formal assessment;
a special education roadmap that provides guidance relating to reading disabilities; and
references to additional resources.
